(19) United States
(12) Patent Application Publication
(10) Pub. No.: US 2026/0099205 A1
(43) Pub. Date: Apr. 9, 2026

(54) EMULATING FLUID BEHAVIOR FOR VIRTUAL ENVIRONMENTS

(71) Applicants: Frank Liu, Alexandria, VA (US); Robert LiKamWa, Houston, TX (US); Ryan Wirjadi, San Diego, CA (US); Shiling Dai, Chandler, AZ (US); Yanjun Lyu, Fremont, CA (US)

(72) Inventors: Frank Liu, Alexandria, VA (US); Robert LiKamWa, Houston, TX (US); Ryan Wirjadi, San Diego, CA (US); Shiling Dai, Chandler, AZ (US); Yanjun Lyu, Fremont, CA (US)

(73) Assignee: Arizona Board of Regents on Behalf of Arizona State University, Scottsdale, AZ (US)

(21) Appl. No.: 19/346,214

(22) Filed: Sep. 30, 2025

Related U.S. Application Data
(60) Provisional application No. 63/703,824, filed on Oct. 4, 2024.

(51) Int. Cl. G06F 3/01

(52) U.S. Cl. CPC G06F 3/016

(57) ABSTRACT

A method is provided for integrating physical interaction with virtual fluid dynamics through coordinated haptic feedback. Position tracking data is obtained for a physical vessel equipped with multiple vibrotactile actuators along an interior surface. A virtual environment is generated for display, including a virtual container corresponding to the physical vessel and a virtual fluid contained therein. User interaction with the physical vessel is detected and compared to an acceleration threshold. When the threshold is satisfied, haptic output is generated from the vibrotactile actuators. The method includes calculating motion of the virtual fluid based on the detected interaction, updating the virtual environment to reflect a relative position of the virtual fluid, calculating a center of gravity of the virtual fluid, and activating selected actuators of the physical vessel based on the calculated center of gravity, thereby producing synchronized tactile feedback responsive to the simulated fluid dynamics.

### CLAIM OF PRIORITY

This application claims the benefit of U.S. Patent Application No. 63/703,824, filed 4 Oct. 2024, the entire contents of which is incorporated herein by reference.

### GOVERNMENT RIGHTS AND GOVERNMENT AGENCY SUPPORT NOTICE

This invention was made with government support under 1917912 and 2202630 awarded by the National Science Foundation. The government has certain rights in the invention.

### TECHNICAL FIELD

Aspects of the invention relate generally to human-computer interaction, including haptics, simulation, and virtual reality technologies.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to examples of the claimed subject matter.

Human-computer interaction technologies have advanced to include increasingly sophisticated methods for rendering visual, auditory, and tactile experiences. Virtual reality systems often employ head-mounted displays and motion tracking to simulate immersive environments. Conventional haptic interfaces generally provide limited feedback, most commonly through handheld controllers that output vibration signals.

Fluid simulation techniques have been developed in computational graphics and physics to model the movement, flow, and interaction of liquids and gasses with their surroundings. These simulations may be used in scientific analysis, engineering applications, training environments, and entertainment systems. Existing approaches vary in complexity and fidelity, but they typically rely on numerical methods to approximate fluid dynamics and visualize corresponding effects within a virtual environment.

### SUMMARY

In general, this disclosure relates to techniques for combining physical vessel interactions with simulated fluid behavior and haptic feedback. A physical vessel can include multiple vibrotactile actuators arranged along an interior surface. Position tracking data from the vessel is obtained and used to render a virtual environment that includes a virtual container corresponding to the physical vessel and a virtual fluid contained within that container. User interaction with the vessel, such as shaking or tilting, is monitored, and when the detected motion satisfies an acceleration threshold, haptic output is triggered. The process may include calculating how the virtual fluid moves in response to the interaction, updating the display to show a new position of the fluid, and determining a center of gravity of the fluid. Based on this calculation, selected actuators of the vessel are activated to generate tactile sensations, providing a coordinated and immersive representation of virtual fluid dynamics.

According to certain examples, the method includes obtaining position tracking data corresponding to a physical vessel equipped with a plurality of vibrotactile actuators arranged along an interior surface of the physical vessel. In one example, the method includes outputting a virtual environment for display to a display interface, wherein the virtual environment includes a virtual container representing the physical vessel and a virtual fluid inside the virtual container. In at least one example, the method includes detecting, based on the position tracking data, that a user interaction with the physical vessel satisfies an acceleration threshold. According to such examples, the method includes, in response to detecting that the user interaction with the physical vessel satisfies the acceleration threshold, providing haptic output from the plurality of vibrotactile actuators. In one example, the providing includes calculating a motion of the virtual fluid within the virtual container using the user interaction detected with the physical vessel. According to certain examples, the providing includes updating the virtual environment to display a relative position of the virtual fluid based on the motion. In at least one example, the providing includes calculating a center of gravity of the virtual fluid based on the motion. According to such examples, the providing includes activating one or more of the plurality of vibrotactile actuators of the physical vessel based on the calculated center of gravity.

According to certain examples, a system includes processing circuitry. In one example, the system includes non-transitory computer-readable media storing instructions that, when executed by the processing circuitry, cause the processing circuitry to obtain position tracking data corresponding to a physical vessel equipped with a plurality of vibrotactile actuators arranged along an interior surface of the physical vessel. In at least one example, the system includes instructions that, when executed, cause the processing circuitry to output a virtual environment for display to a display interface, wherein the virtual environment includes a virtual container representing the physical vessel and a virtual fluid inside the virtual container. According to such examples, the system includes instructions that, when executed, cause the processing circuitry to detect, based on the position tracking data, that a user interaction with the physical vessel satisfies an acceleration threshold. In one example, the system includes instructions that, when executed, cause the processing circuitry, in response to detecting that the user interaction with the physical vessel satisfies the acceleration threshold, to provide haptic output from the plurality of vibrotactile actuators.

According to certain examples, to provide the haptic output, the processing circuitry is further configured to calculate a motion of the virtual fluid within the virtual container using the user interaction detected with the physical vessel. In one example, to provide the haptic output, the processing circuitry is further configured to update the virtual environment to display a relative position of the virtual fluid based on the motion. In at least one example, to provide the haptic output, the processing circuitry is further configured to calculate a center of gravity of the virtual fluid based on the motion. According to such examples, to provide the haptic output, the processing circuitry is further configured to activate one or more of the plurality of vibrotactile actuators of the physical vessel based on the calculated center of gravity.

According to certain examples, a non-transitory computer-readable medium stores instructions that, when executed by processing circuitry, cause the processing circuitry to obtain position tracking data corresponding to a physical vessel equipped with a plurality of vibrotactile actuators arranged along an interior surface of the physical vessel. In one example, the non-transitory computer-readable medium stores instructions that, when executed, cause the processing circuitry to output a virtual environment for display to a display interface, wherein the virtual environment includes a virtual container representing the physical vessel and a virtual fluid inside the virtual container. In at least one example, the non-transitory computer-readable medium stores instructions that, when executed, cause the processing circuitry to detect, based on the position tracking data, that a user interaction with the physical vessel satisfies an acceleration threshold. According to such examples, the non-transitory computer-readable medium stores instructions that, when executed, cause the processing circuitry, in response to detecting that the user interaction with the physical vessel satisfies the acceleration threshold, to provide haptic output from the plurality of vibrotactile actuators. In one example, to provide the haptic output, the instructions further configure the processing circuitry to calculate a motion of the virtual fluid within the virtual container using the user interaction detected with the physical vessel. In at least one example, to provide the haptic output, the instructions further configure the processing circuitry to update the virtual environment to display a relative position of the virtual fluid based on the motion. According to certain examples, to provide the haptic output, the instructions further configure the processing circuitry to calculate a center of gravity of the virtual fluid based on the motion. In one example, to provide the haptic output, the instructions further configure the processing circuitry to activate one or more of the plurality of vibrotactile actuators of the physical vessel based on the calculated center of gravity.

In a particular example, there is a device which includes means for obtaining position tracking data corresponding to a physical vessel equipped with a plurality of vibrotactile actuators arranged along an interior surface of the physical vessel. The device further includes means for outputting a virtual environment for display to a display interface, wherein the virtual environment includes a virtual container representing the physical vessel and a virtual fluid inside the virtual container. The device includes means for detecting, based on the position tracking data, that a user interaction with the physical vessel satisfies an acceleration threshold. The device also includes means for providing haptic output from the plurality of vibrotactile actuators in response to detecting that the user interaction with the physical vessel satisfies the acceleration threshold. The means for providing haptic output include means for calculating a motion of the virtual fluid within the virtual container using the user interaction detected with the physical vessel. The means for providing haptic output also include means for updating the virtual environment to display a relative position of the virtual fluid based on the motion. The means for providing haptic output further include means for calculating a center of gravity of the virtual fluid based on the motion. The means for providing haptic output also include means for activating one or more of the plurality of vibrotactile actuators of the physical vessel based on the calculated center of gravity.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating further details of one example of a computing device, in accordance with aspects of the disclosure.

FIG. 2 depicts a fluid emulation framework equipped with multiple vibrotactile actuators to emulate the haptic sensation of virtual liquid within a container, in accordance with aspects of the disclosure.

FIG. 3 depicts a conceptual system diagram for a fluid emulation framework, in accordance with aspects of the disclosure.

FIG. 4 depicts a conceptual electronic schematic using a nano board mounted on a perma-proto board as part of fluid emulation hardware, in accordance with aspects of the disclosure.

FIG. 5 depicts an example implementation of fluid emulation hardware and a virtual environment, in accordance with aspects of the disclosure.

FIG. 6A illustrates results for a water bottle equipped with a contact microphone, in accordance with aspects of the disclosure.

FIG. 6B illustrates results for a metal cup with a contact microphone, in accordance with aspects of the disclosure.

FIG. 6C illustrates results for a glass flask with a contact microphone, in accordance with aspects of the disclosure.

FIGS. 7A, 7B, and 7C depict acoustic vibration samples of liquid interaction events captured using two contact microphones mounted on opposing surfaces of different physical containers, in accordance with aspects of the disclosure.

FIG. 8 depicts user interactions, in accordance with aspects of the disclosure.

FIG. 9 depicts a set of physical vessels, each configured with different numbers of vibrotactile motors to illustrate varying motor densities, in accordance with aspects of the disclosure.

FIG. 10 depicts a table providing user rating scores for motor density conditions including four motors, six motors, and eight motors, in accordance with aspects of the disclosure.

FIG. 11 depicts a comparative frontal view of physical vessels illustrating two alternative motor placement configurations, in accordance with aspects of the disclosure.

FIG. 12 depicts a table providing user rating scores for direct touch conditions, including configurations with vibrotactile motor inside placement and vibrotactile motor outside placement mounted on physical vessels respectively, in accordance with aspects of the disclosure.

FIG. 13 depicts a frontal view of physical vessels configured to operate at different motor strength conditions, in accordance with aspects of the disclosure.

FIG. 14 depicts a table providing user rating scores for motor strength conditions corresponding to motor strengths of 150, 200, and 255, in accordance with aspects of the disclosure.

FIG. 15 depicts a sequence of user trials highlighting differing interaction modalities with a fluid emulation framework, in accordance with aspects of the disclosure.

FIG. 16 depicts a table providing object realism scores for a shape-only static haptic proxy, a fluid emulation framework with vibrations, and liquid in a flask, in accordance with aspects of the disclosure.

FIG. 17 depicts a user wearing a VR headset and engaging with a handheld vessel across three representative vessel conditions, including a beaker, a Florence flask, and an Erlenmeyer flask, in accordance with aspects of the disclosure.

FIG. 18 depicts a table providing object realism scores for vessel shapes including a beaker, a Florence flask, and an Erlenmeyer flask, in accordance with aspects of the disclosure.

FIG. 19 is a flow diagram illustrating an example method for generating haptic feedback based on interactions with a physical vessel, in accordance with aspects of the disclosure.

Like reference characters denote like elements throughout the text and figures.

### DETAILED DESCRIPTION

In general, this disclosure relates to techniques for combining physical vessel interactions with simulated fluid behavior and haptic feedback. A physical vessel can include multiple vibrotactile actuators arranged along an interior surface. Position tracking data from the vessel is obtained and used to render a virtual environment that includes a virtual container corresponding to the physical vessel and a virtual fluid contained within that container. User interaction with the vessel, such as shaking or tilting, is monitored, and when the detected motion satisfies an acceleration threshold, haptic output is triggered. The process may include calculating how the virtual fluid moves in response to the interaction, updating the display to show a new position of the fluid, and determining a center of gravity of the fluid. Based on this calculation, selected actuators of the vessel are activated to generate tactile sensations, providing a coordinated and immersive representation of virtual fluid dynamics.

Temporally asymmetric vibrotactile feedback refers to haptic output that changes over time in a non-uniform fashion. Unlike symmetric feedback, in which vibrations remain steady in strength and timing, temporally asymmetric feedback may vary in intensity, duration, or pattern across different moments of interaction. For instance, a sequence of rapid short pulses may be followed by a longer, stronger pulse. Such variations create a dynamic and realistic sensation that can promote deeper user immersion within a virtual environment.

The fluid emulation framework leverages these characteristics to provide enhanced realism by simulating sensations that mirror fluid movement, shifting weight, or other natural physical interactions. In real-world scenarios, tactile experiences with fluids or materials rarely remain constant, and incorporating temporal variation allows systems to better approximate these sensations. By aligning feedback more closely with the complexity of natural touch, users may perceive more lifelike and engaging interactions.

This framework can be integrated into a variety of environments, including virtual reality applications, gaming systems, training simulations, and therapeutic platforms. Each of these contexts can benefit from realistic tactile sensations that enhance immersion, strengthen the sense of presence, and improve overall user engagement.

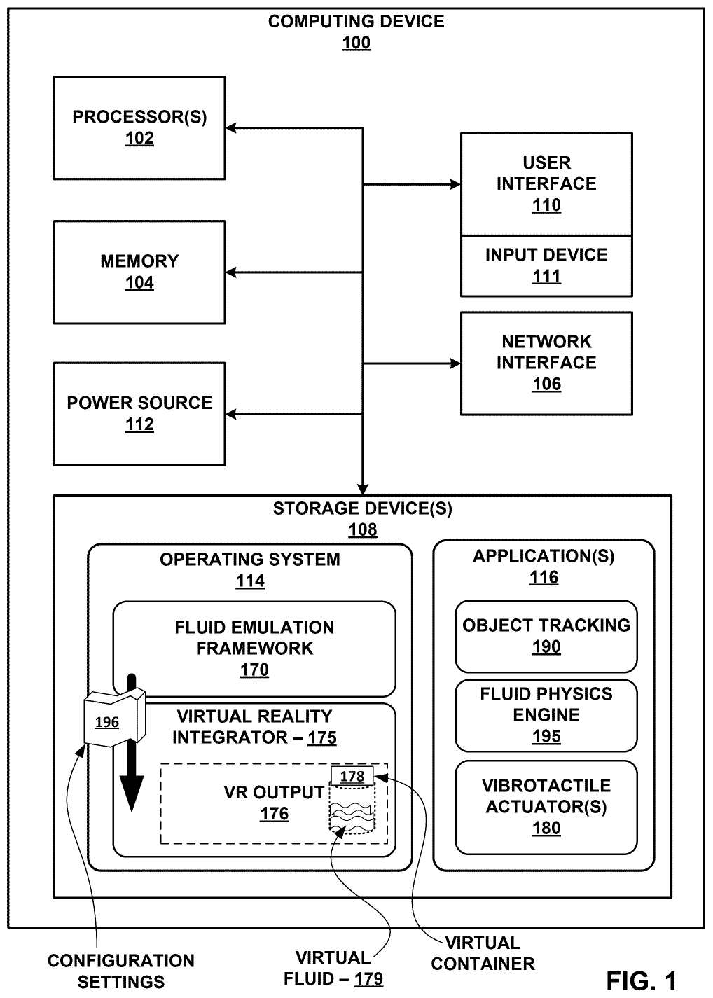

FIG. 1 is a block diagram illustrating further details of one example of computing device, in accordance with aspects of this disclosure. FIG. 1 illustrates only one particular example of computing device 100. Many other example embodiments of computing device 100 may be used in other instances.

As shown in the specific example of FIG. 1, computing device 100 may include processor(s) 102, memory 104, network interface 106, storage device(s) 108, user interface 110, input device 111, and power source 112. Computing device 100 may also include operating system 114. Computing device 100, in one example, may further include application(s) 116, including object tracking 190, fluid physics engine 195, and vibrotactile actuator(s) 180, which together support functionality for modeling virtual fluid 179 within virtual container 178 and for coordinating haptic feedback output.

Operating system 114 may execute fluid emulation framework 170 in conjunction with object tracking 190, fluid physics engine 195, and vibrotactile actuator(s) 180 to provide realistic fluid emulation and haptic feedback to a virtual reality environment through virtual reality integrator 175. Virtual reality output 176 generated by virtual reality integrator 175 may include representations of virtual container 178 and virtual fluid 179 and may be custom modifiable using configuration settings 196. Configuration settings 196 may define parameters such as viscosity, container geometry, size, or mass, which can directly affect the tactile sensations generated through vibrotactile actuator(s) 180.

In some examples, processing circuitry including processor(s) 102 implements functionality and/or process instructions for execution within computing device 100. For example, processor(s) 102 may be capable of processing instructions stored in memory 104 and/or instructions stored on storage device(s) 108. Processor(s) 102 may execute object tracking 190 to obtain position tracking data associated with user interaction, process the data using fluid physics engine 195 to simulate movement of virtual fluid 179 in virtual container 178, and coordinate the resulting haptic output via vibrotactile actuator(s) 180.

Memory 104, in one example, may store information within computing device 100 during operation. Memory 104, in some examples, may represent a computer-readable storage medium. In some examples, memory 104 may be a temporary memory, meaning that a primary purpose of memory 104 may not be long-term storage. Memory 104, in some examples, may be described as a volatile memory, meaning that memory 104 may not maintain stored contents when computing device 100 is turned off. Examples of volatile memories may include random access memories (RAM), dynamic random-access memories (DRAM), static random-access memories (SRAM), and other forms of volatile memories. In some examples, memory 104 may be used to store program instructions for execution by processor(s) 102. Memory 104, in one example, may be used by software or application(s) 116 to temporarily store data and/or instructions during program execution. For instance, intermediate state updates of virtual fluid 179 may be held in memory 104 while being processed by fluid physics engine 195.

Storage device(s) 108, in some examples, may also include one or more computer-readable storage media. Storage device(s) 108 may be configured to store larger amounts of information than memory 104. Storage device(s) 108 may further be configured for long-term storage of information. In some examples, storage device(s) 108 may include non-volatile storage elements. Examples of such non-volatile storage elements may include magnetic hard disks, optical discs, floppy disks, Flash memories, or forms of electrically programmable memories (EPROM) or electrically erasable and programmable (EEPROM) memories. Storage device(s) 108 may hold operating system 114, application(s) 116, and configuration settings 196 that define how virtual fluid 179 behaves when simulated within virtual container 178.

Computing device 100, in some examples, may also include network interface 106. Computing device 100, in such examples, may use network interface 106 to communicate with external devices via one or more networks, such as wired or wireless networks. Network interface 106 may be a network interface card, such as an Ethernet card, an optical transceiver, a radio frequency transceiver, a cellular transceiver, or any other type of device that can send and receive information. Other examples of such network interfaces may include Bluetooth, 3G, 4G, 5G, LTE, and Wi-Fi radios in mobile computing devices, as well as USB. In some examples, computing device 100 may use network interface 106 to wirelessly communicate position tracking data or transmit haptic configuration updates to remote servers or VR platforms.

Computing device 100 may also include user interface 110. User interface 110 may include input device 111, which may be configured to receive input from a user through tactile, electromagnetic, audio, and/or video feedback. Examples of input device 111 may include a touch-sensitive display, mouse, keyboard, voice responsive system, video camera, microphone, or any other type of device for detecting gestures by a user. In some examples, input device 111 may work with object tracking 190 to derive motion data associated with user interaction.

User interface 110 may also include one or more output devices, such as a display screen or VR headset associated with virtual reality output 176. Output devices may be configured to provide visual or audio representations of virtual container 178 and virtual fluid 179 to the user. One or more output devices, in one example, may include a display, sound card, a video graphics adapter card, or any other type of device for converting a signal into an appropriate form understandable to humans or machines. Additional examples of output devices may include a speaker, a cathode ray tube (CRT) monitor, a liquid crystal display (LCD), or other devices capable of displaying VR or AR content.

Power source 112 may provide energy to computing device 100. Power source 112 may be rechargeable and may be based on nickel-cadmium, lithium-ion, or other suitable material. Power source 112 may enable portable implementations of computing device 100, such as handheld or head-mounted VR systems.

Operating system 114 may be stored in storage device(s) 108 and may control the operation of components of computing device 100. For example, operating system 114 may facilitate the interaction of application(s) 116 with hardware components of computing device 100. Fluid emulation framework 170 may operate within operating system 114 to integrate object tracking 190, fluid physics engine 195, and vibrotactile actuator(s) 180.

Object tracking 190 may obtain position tracking data. Fluid physics engine 195 may process this tracking data to model how virtual fluid 179 behaves inside virtual container 178, including calculating motion, relative positions, and center of gravity. Vibrotactile actuator(s) 180 may use this data to drive physical actuators to simulate tactile sensations corresponding to virtual fluid 179.

Virtual reality integrator 175 may combine data from fluid emulation framework 170 with configuration settings 196 to produce virtual reality output 176. Virtual reality output 176 may include images or VR signals representing virtual container 178 and virtual fluid 179, with behavior responsive to user interaction. Configuration settings 196 may allow tailoring of parameters such as viscosity, fluid density, or vibration profiles to create varied haptic experiences.

In this way, FIG. 1 illustrates computing device 100 configured with hardware and software components that enable coordinated simulation of fluid dynamics and haptic feedback. The architecture integrates object tracking 190, fluid physics engine 195, fluid emulation framework 170, and vibrotactile actuator(s) 180 to provide immersive, realistic user interaction with virtual fluid 179 inside virtual container 178, synchronized with tactile sensations generated by vibrotactile actuator(s) 180.

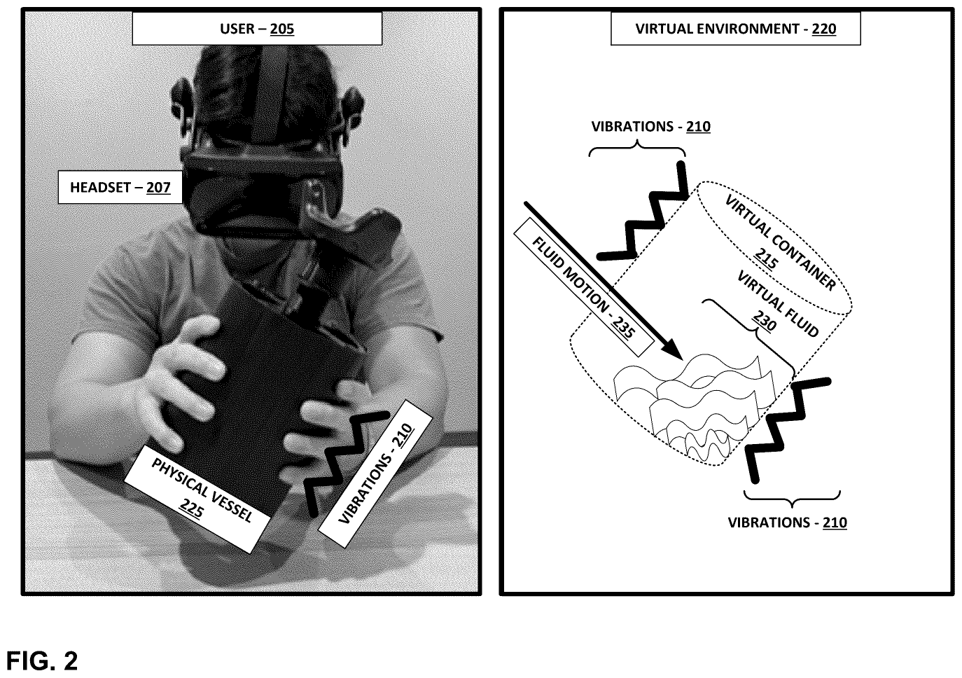

FIG. 2 depicts fluid emulation framework 170 equipped with multiple vibrotactile actuators to emulate the haptic sensation of virtual liquid within a container, in accordance with aspects of the disclosure. For example, user 205 interacting with fluid emulation framework 170 through physical vessel 225 may perceive vibrations 210 as output by the actuators when virtual fluid 230 impacts virtual container 215 within virtual environment 220. Headset 207 may present virtual environment 220 to user 205, allowing the user to view visual representations of virtual container 215 and virtual fluid 230. Additionally, fluid emulation framework 170 may calculate fluid motion 235 based on position tracking of physical vessel 225, providing both visual and haptic synchronization.

Virtual reality (VR) experiences often lack realistic haptic feedback, particularly in scenarios involving interactions with virtual fluids 230. Previously known techniques for haptic feedback related to virtual fluids are neither easily scalable nor readily recreated. Fluid emulation framework 170 enables enhanced user interaction with virtual fluids through spatially and temporally asymmetric vibrotactile feedback. In accordance with aspects of the disclosure, fluid emulation framework 170 may incorporate multiple vibrotactile actuators to generate vibrations 210, strategically placed around the interior of physical vessel 225, synchronized with virtual fluid dynamics in virtual environment 220. Fluid emulation framework 170 may be configured to obtain and analyze motor density information (e.g., provided via a priori configuration information), direct touch inputs from physical vessel 225 detected while in use, and generate configurable vibration 210 strength output to affect user perceptions of virtual fluid sensations relative to virtual container 215 within virtual environment 220. User feedback reveals that fluid emulation framework 170 effectively simulates dynamic weight shifts and fluid sensations, with participants reporting experiences that closely resemble real-world interactions with fluids. These findings contribute to the development of adaptable and scalable haptic applications for virtual fluids 230, providing insights into optimizing parameters for realistic and perceptually realistic simulated virtual fluid 230 experiences in virtual environments 220.

Human-computer interaction (HCI) research within such virtual environments has advanced significantly in simulating realistic sensations to enhance user experiences. However, accurately reproducing fluid sensations in these environments presents a continuing challenge. Two distinct approaches for dynamically shifting weight to simulate the haptic sensation of virtual fluid 230 behavior include actively shifting weights that may simulate the sensation of virtual fluid in containers. Incorporating moving mechanical systems, however, actively shifting weights becomes increasingly challenging as virtual container 215 size decreases due to a corresponding reduction of physical vessel 225 size. Lightweight form factors and simplicity in haptic devices enhance user immersion within virtual environment 220 and improve the overall user experience by promoting comfort during prolonged usage. Vibrotactile actuators, known for their accessibility, compact design, and expressiveness, have demonstrated their effectiveness in simulating various haptic illusions, including bending and stretching rigid objects, stiffness, forces, and textures. Fluid emulation framework 170 utilizes vibrotactile actuators to effectively emulate the sensation of virtual fluids 230 within virtual environment 220.

Prior techniques have employed vibrations to simulate the sensation of dynamic mass for solid virtual objects, such as coins in a jar. However, user feedback indicated that such techniques were ineffective in simulating fluids. This limitation may stem from the one-axis pseudo-force feedback being unable to capture the full range of fluid expressiveness. Another technique utilized multi-actuator vibrotactile feedback to simulate wine in a bottle. To replicate the illusion of fluid inside virtual container 215, researchers employed an underdamped spring attached to a virtual mass at the object's center, causing the mass to lag and oscillate during movement pauses. The amplitude of vibration on each actuator was inversely proportional to the distance from the mass, creating a tactile sensation of motion between two actuator locations. However, this one-dimensional approach proved insufficient in capturing the expressive behaviors of actual liquids.

In accordance with aspects of the disclosure, fluid emulation framework 170 may apply asymmetric vibrations to enable the sensation of direction and pseudoforces. For example, fluid emulation framework 170 may utilize vibrotactile actuators to convey the haptic sensation of virtual fluids 230. The application of fluid emulation framework 170 is based on the dynamic behavior of liquids, emphasizing kinesthetic forces and surface vibrations during collisions between virtual fluids 230 and virtual containers 215. Fluid emulation framework 170 emulates the manner in which weight shifts of liquids and splashes occur in the real world and map those physical effects to virtual environment 220 using vibrotactile actuation. Fluid emulation framework 170 serves as a haptic device equipped with, in some examples, up to eight vibrotactile motors, arranged in a circular array along the sides of physical vessel 225. When user 205 interacts with physical vessel 225, vibration 210 impulses activate the vibrotactile motors. These impulses are triggered when the center of gravity (CoG) of virtual fluid 230, calculated as part of fluid motion 235, aligns with virtual container 215 and exceeds a predefined acceleration threshold. Pulsing binary vibrotactile actuators in this manner introduces haptic asymmetry through spatial and temporal variation, resulting in a non-uniform tactile sensation for user 205.

In such a way, fluid emulation framework 170 enables adaptable, scalable, and general-purpose haptic applications for virtual fluids 230. Fluid emulation framework 170 is configurable to accommodate varying motor density, direct contact inputs from users, and desired vibration strength to shape user perceptions of dynamic weight shifts and virtual fluid 230 sensations within virtual container 215. The configurable parameters enable fluid emulation framework 170 to deliver the most favorable user experience.

Experiments compared perceptual user feedback with real liquid and a static haptic proxy, examining how well fluid emulation framework 170 generalized to different physical vessel 225 shapes. Sixteen users participated in both cases, frequently associating the tactile sensations provided by fluid emulation framework 170 with the sensation of real liquid in a real container. Results demonstrated that fluid emulation framework 170 successfully provided the haptic sensation of virtual fluid 230 in virtual container 215 within virtual environment 220.

Handheld haptic devices: While commercial VR controllers are portable and easy to use, many off-the-shelf controllers only provide basic vibrotactile feedback for virtual object interaction. Numerous handheld haptic interfaces have been developed to enhance sensations in virtual environment 220. The Haptic Revolver enables standard VR controller functionality while also rendering texture and contact sensations of various objects through a configurable wheel on the device. CLAW augments traditional controllers by incorporating force feedback and actuated movement of the index finger. PaCaPa and CapstanCrunch feature movable arms that generate touch sensation, grasp force feedback, and object textures through vibration. HaptiVec modifies controllers to enable users to feel directional haptic pressure vectors, while X-Rings introduces shape-changing controllers. Despite these enhanced virtual sensations, the complexity of the mechanical structures in these systems limits their generalizability, especially with respect to emulating virtual fluids 230 within virtual container 215 as provided by fluid emulation framework 170.

Vibrotactile sensation: Vibrotactile motors have been employed in research to create a wide array of haptic illusions, including bending, stretching of rigid objects, stiffness, compliance, forces, and textures. TORC introduces a rigid haptic controller that renders characteristics and behaviors of virtual objects, such as texture and compliance. Grabity is a handheld controller concept that applies asymmetric vibration and skin stretch feedback to simulate varying levels of perceived weight for virtual objects, creating an illusion of gravity. DualVib is a handheld haptic interface that incorporates dual vibration actuators to emulate the perception of dynamic mass for virtual solid objects, such as coins in a jar. Although generally effective for solid simulations, studies of DualVib revealed limitations in reproducing realistic sensations for virtual fluids, as the system primarily provided one-axis pseudo-force feedback. Other investigations have used multi-actuator vibrotactile feedback to replicate the sensation of wine in a bottle, with vibration actuation following a spring oscillation pattern. However, this one-dimensional approach did not accurately capture the expressive behaviors of real liquids. Such one-dimensional vibrotactile feedback techniques fall short in characterizing the haptic sensations of virtual fluids as is provided by fluid emulation framework 170.

Dynamic weight shift: The exploration of dynamic weight shift in haptic feedback has attracted attention in recent research. TorqueBAR changes its center of mass along one degree of freedom, shifting the center-of-mass in real time as the user tilts the device, based on a computer-controlled algorithm. Shifty shifted weight along its main axis to alter rotational inertia, introducing the concept of dynamic passive haptic feedback. Researchers have investigated various weight-shifting mechanisms, employing wind, air resistance, liquid, string-driven systems, rack and pinion mechanisms, and vibration. Many of these systems exhibit mechanical complexity, making replication difficult. Some designs are bulky and uncomfortable during prolonged use, indicating the need for more accessible and user-friendly designs in the study of dynamic weight shift within haptic feedback systems. Unlike prior techniques, fluid emulation framework 170 not only enables a realistic simulation of virtual fluids 230 in virtual containers 215 within virtual environment 220, but also utilizes a mechanically straightforward solution, utilizing vibrotactile actuators to offer a user-friendly and mechanically simple haptic feedback system.

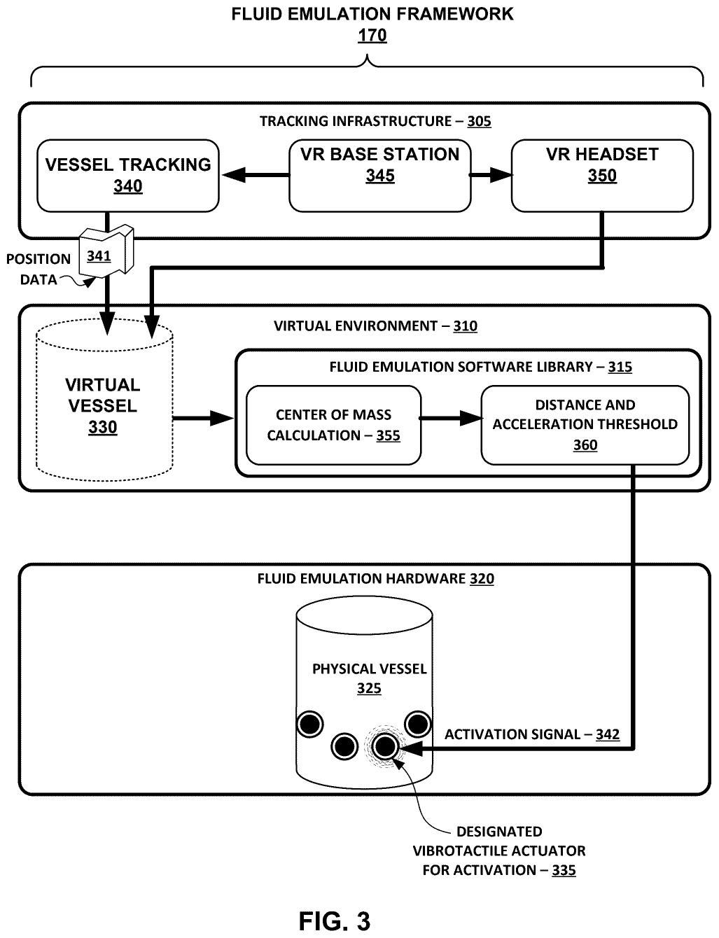

FIG. 3 depicts a conceptual system diagram for fluid emulation framework 170, in accordance with aspects of the disclosure. Fluid emulation framework 170 illustrates the interaction between tracking infrastructure 305, virtual environment 310, and fluid emulation hardware 320 in generating vibrotactile feedback for the perception of virtual fluid motion. FIG. 3 is described with respect to computing device 100 of FIG. 1, although the techniques of FIG. 3 may be implemented by additional or alternative systems.

Tracking infrastructure 305 includes vessel tracking 340, VR base station 345, and VR headset 350. Vessel tracking 340 may comprise, for example, a Vive tracker or other external tracking device configured to provide real-time position and orientation of physical vessel 325. VR base station 345 may operate as a lighthouse system, emitting structured light to triangulate the position of vessel tracking 340 and VR headset 350. VR headset 350, which may include devices such as the HTC Vive Pro, receives tracking information from VR base station 345 and outputs immersive visual information to a user within virtual environment 310. Tracking infrastructure 305 thereby generates position data 341 representative of the physical movements of physical vessel 325 and communicates the position data 341 to virtual environment 310.

Virtual environment 310 includes virtual vessel 330 and fluid emulation software library 315. Virtual vessel 330 represents physical vessel 325 in the rendered scene, and may be populated with simulated liquid behavior using fluid physics engines such as ObiFluid. Fluid emulation software library 315 includes center of mass calculation 355 and distance and acceleration threshold 360. Center of mass calculation 355 computes the instantaneous position of virtual fluid within virtual vessel 330, based on the relative motion of physical vessel 325 as indicated by position data 341. Distance and acceleration threshold 360 determines whether detected user interactions satisfy predefined conditions for generating haptic feedback, such as acceleration exceeding a threshold magnitude or virtual fluid contacting a wall of virtual vessel 330. These calculations produce activation signal 342 that indicates which vibrotactile actuator within physical vessel 325 should be triggered.

Fluid emulation hardware 320 includes physical vessel 325 with multiple vibrotactile actuators positioned along its interior surface. In one example, up to eight vibrotactile actuators may be arranged in a circular array. Fluid emulation hardware 320 receives activation signal 342 from fluid emulation software library 315 and routes the signal to designated vibrotactile actuator for activation 335. By activating designated vibrotactile actuator for activation 335 corresponding to the location of virtual fluid impact within virtual vessel 330, fluid emulation hardware 320 produces localized vibrations that emulate the sensation of real liquid motion. The resulting vibrotactile output provides a user with an immersive perception of dynamic weight shift, splashing, and impact forces associated with virtual fluid interaction.

In this way, FIG. 3 illustrates how fluid emulation framework 170 integrates tracking infrastructure 305, virtual environment 310, and fluid emulation hardware 320 to deliver synchronized visual and haptic feedback. By combining position data 341, center of mass calculation 355, and distance and acceleration threshold 360 to generate activation signal 342, the system enables physical vessel 325 to output vibrotactile sensations through designated vibrotactile actuator for activation 335, thus simulating the expressive behaviors of virtual fluid within virtual vessel 330 as represented within virtual environment 310.

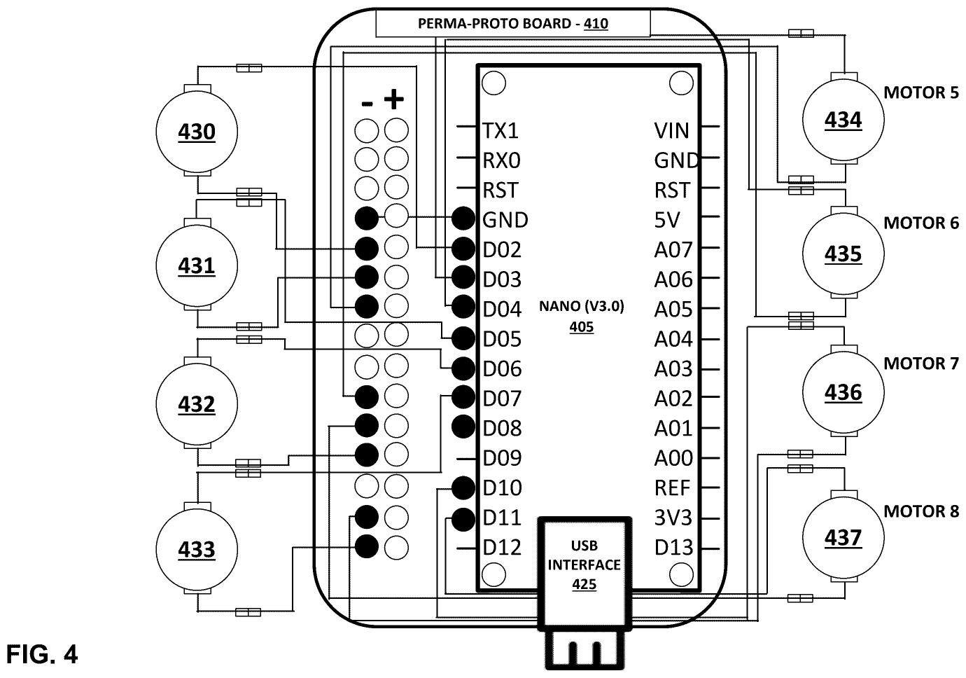

FIG. 4 depicts a conceptual electronic schematic using nano 405 mounted on perma-proto board 410 as part of fluid emulation hardware 320, in accordance with aspects of the disclosure. Motors 430, 431, 432, 433, 434, 435, 436, and 437, implemented as vibrotactile actuators, connect to nano 405 through wiring on perma-proto board 410. USB interface 425 provides a serial communication connection to nano 405 for both data transfer and power input, although in other examples wireless connectivity, such as via a Bluetooth RF transceiver, may be utilized.

Fluid emulation framework 170 incorporates nano 405 and perma-proto board 410 within physical vessel 325. Physical vessel 325 may be a 3D-printed housing or an off-the-shelf container geometry, sized for easy embedding of fluid emulation hardware 320. For one example, physical vessel 325 may be fabricated with dimensions of 5.8×3.9×2.7 cm and a weight of 6 g.

Motors 430-437 may be flat coreless vibration motors measuring 10 mm ×3 mm and weighing 2 g each. Each motor has a rated frequency of 200 Hz, a rated current of 85 mA, and an internal resistance of 15.2 Ω. At 5 V, each motor draws approximately 1.64 W. The positive lead of each motor connects to a digital PWM pin of nano 405, and the negative lead connects to a ground pin. The PWM pins permit modulation of voltage delivered to motors 430-437, thereby enabling control of vibration strength, intensity, and timing. This configuration supports both spatial variation across actuator locations and temporal variation of activation timing, corresponding to motion of virtual fluid as determined within fluid emulation framework 170.

When combined with position tracking data from vessel tracking 340 of FIG. 3, the configuration of FIG. 4 allows fluid emulation hardware 320 to deliver haptic output responsive to acceleration thresholds and calculated center of gravity of virtual fluid. Selected ones of motors 430-437 may be activated based on these calculations, producing tactile sensations that emulate dynamic weight shifts and impact forces of virtual fluid within virtual vessel 330 of virtual environment 310.

In one configuration, the aggregate weight of fluid emulation hardware 320 including nano 405, perma-proto board 410, and jumper cables totals 18 g. An additional 6 g accounts for casing weight, and each motor 430-437 contributes 2 g. A maximum eight-motor configuration therefore weighs approximately 42 g. When integrated with a cylindrical 3D-printed vessel, the system weighs about 270 g, and the complete assembly of fluid emulation framework 170 totals approximately 371 g.

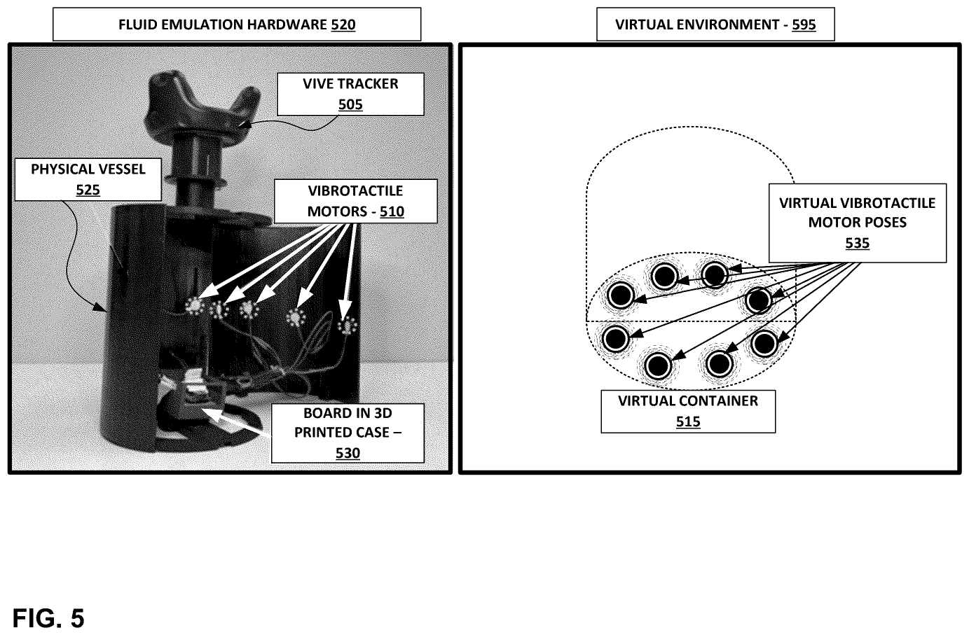

FIG. 5 depicts an example implementation of fluid emulation hardware 520 and virtual environment 595, in accordance with aspects of the disclosure. As depicted, fluid emulation hardware 520 includes physical vessel 525, vive tracker 505, board in 3D printed case 530, vibrotactile motors 510, and associated electronics. Virtual environment 595 includes virtual vibrotactile motor poses 535 within virtual container 515. Virtual container 515 may be filled with virtual fluid and may include invisible game objects positioned near the bottom of virtual container 515, with positions corresponding to vibrotactile motors 510 arranged within physical vessel 525.

Software implementation of fluid emulation framework 170 may operate using the Unity game engine. For fluid simulation, Obi Fluid may be selected to perform real-time fluid dynamics optimized for Unity. Obi Fluid exposes adjustable parameters including viscosity, volume of fluid, and other properties. Configuration settings allow modification of these parameters to vary the behavior of virtual fluid within virtual container 515.

When interaction occurs with virtual fluid within virtual container 515, such as shaking a bottle side to side, users perceive mass of the fluid impacting walls of virtual container 515. Liquids in containers tend to move together as cohesive masses. Rapid shaking of virtual container 515 produces pronounced tactile sensations of liquid mass, while slow side-to-side motions may result in little or no perceptible vibration feedback.

Fluid emulation framework 170 seeks to capture kinesthetic force and surface vibration effects produced by liquid movement and collisions between virtual fluid and surfaces of virtual container 515. Kinesthetic force refers to sensory perception of movement and spatial orientation through proprioception involving muscles, joints, and the vestibular system. Kinesthetic force contributes to motor control, motion coordination, and perception of realism. In the context of virtual environment 595, kinesthetic force enhances user immersion by aligning tactile feedback with expected physical interactions.

Experimental observations indicate that virtual fluid behaves cohesively, so the center of gravity of virtual fluid may be calculated and used as a proxy for collective motion. Virtual environment 595 may spawn virtual fluid into virtual container 515, which may in some implementations be geometrically identical to physical vessel 525. Virtual container 515 may be defined by an object file that maps to the same dimensions as physical vessel 525. Invisible game objects positioned near the bottom of virtual container 515 may correspond to virtual vibrotactile motor poses 535. Vibrotactile motors 510 may be arranged in a circular array around the interior wall of physical vessel 525, offset relative to positions of virtual vibrotactile motor poses 535. This arrangement allows haptic feedback to be delivered at locations consistent with user perception, while the virtual liquid tends to remain near the bottom of virtual container 515.

Unity transmits motor control commands to fluid emulation framework 170, which activates vibrotactile motors 510 when the center of gravity of virtual fluid approaches walls of virtual container 515 and exceeds an acceleration threshold. Vibrotactile motors 510 output pulses in response to fast shaking, swirling, or impact events, while remaining inactive during slow movements. Vibrotactile motors 510 may also be synchronized to vibrate together when virtual fluid moves upward and downward within virtual container 515, producing coordinated sensations of fluid sloshing. As vibrotactile motors 510 follow the motion of the center of gravity of virtual fluid, spatial and temporal variation introduces haptic asymmetry. Vibrations occur during transient motion events, generating sensations of impact consistent with prior findings that transient vibrations contribute to realistic contact perception. Fluid emulation framework 170 thereby provides tactile output aligned with expected real-world liquid handling.

Fluid emulation framework 170 also supports configurability. Developers may program distance and acceleration thresholds to tune responsiveness. To determine suitable acceleration parameters, simulations of 10 minutes of virtual fluid motion at varied speeds may be run, and thresholds may be selected based on distribution of measured acceleration values. For example, thresholds may be chosen at the 25th percentile of measured acceleration to provide sensitivity to meaningful motion without oversensitivity to minor disturbances. A nominal distance threshold of 1 cm may be employed. Additional fluid behavior parameters may be modified through Obi Fluid settings within Unity.

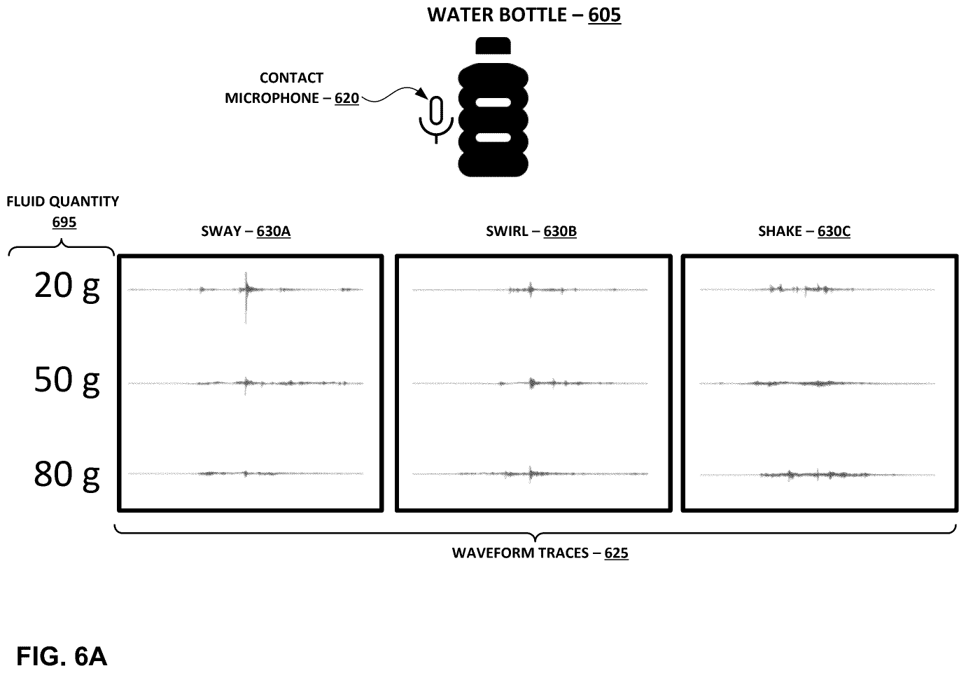

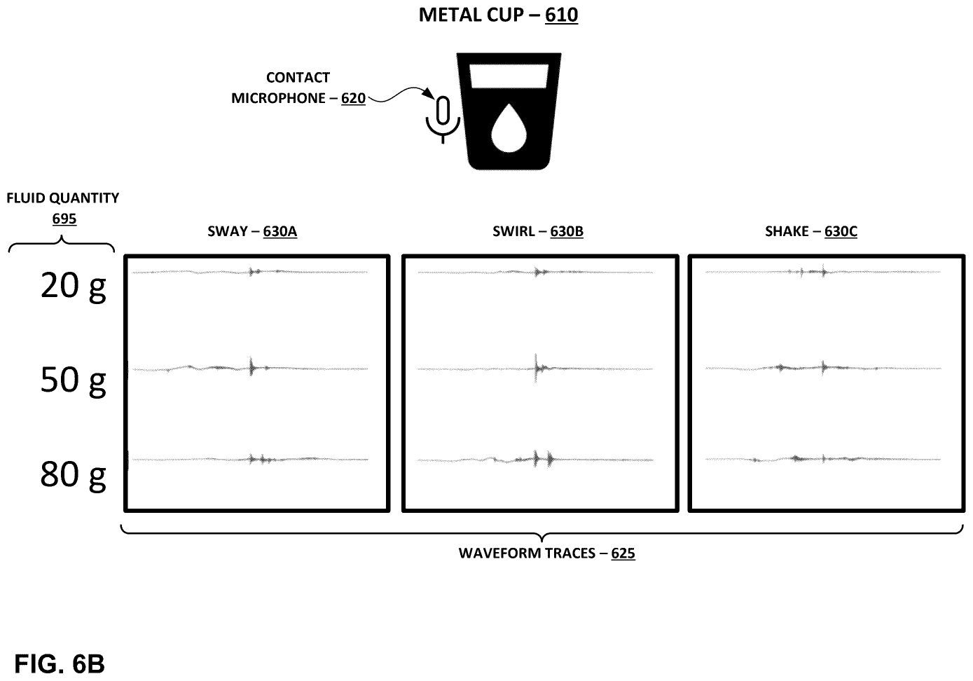

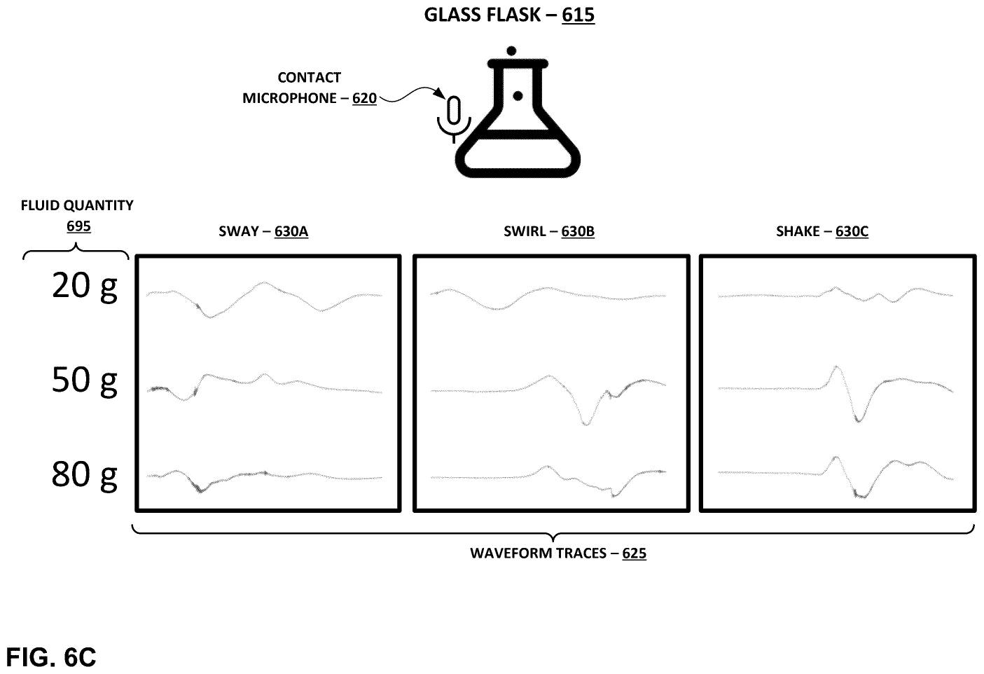

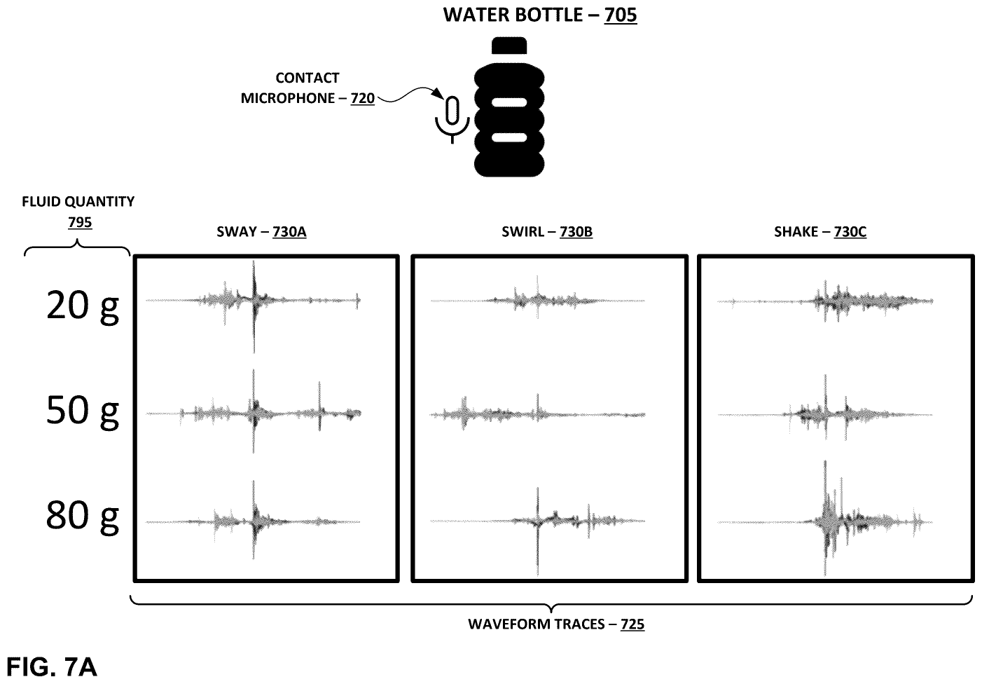

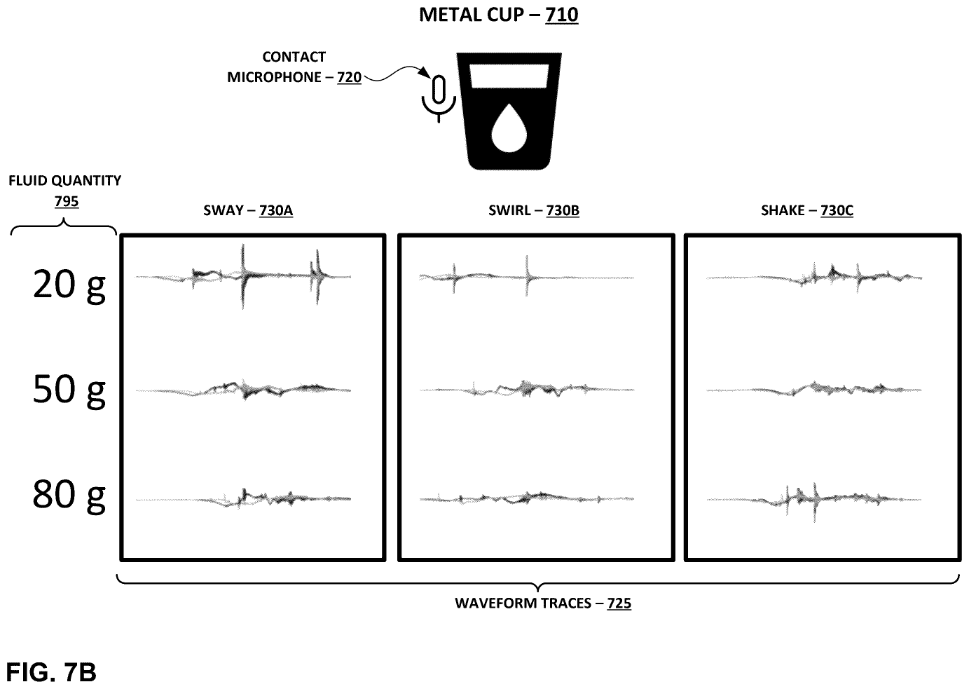

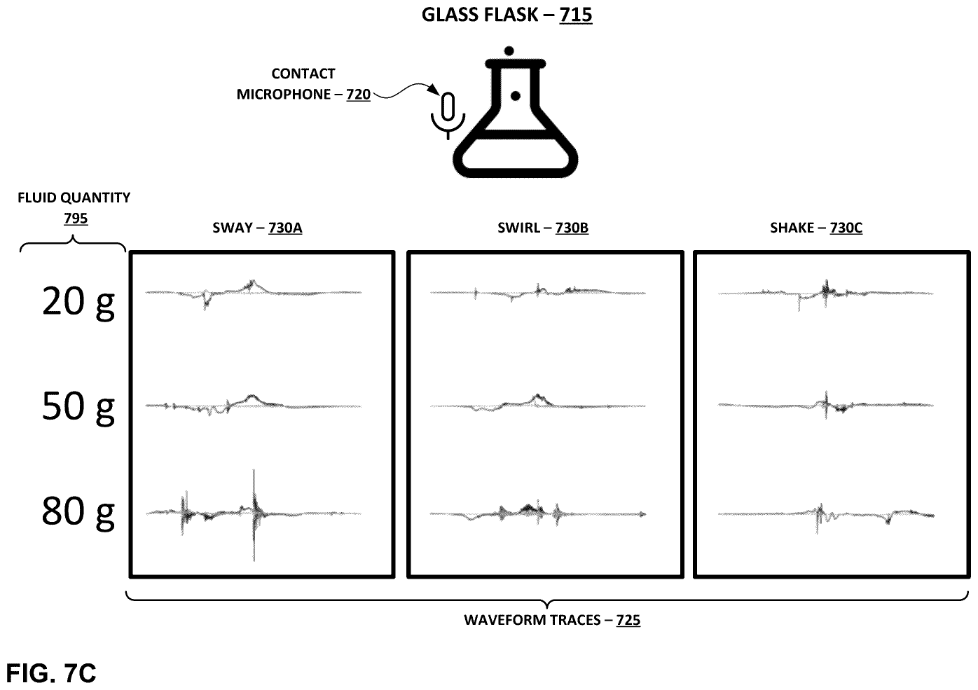

Experiments were conducted to study physical liquids impacting container surfaces and producing acoustic vibrations. Contact microphones were attached to three vessel types: a plastic water bottle, a metal cup, and a glass flask. Water quantities of 20 g, 50 g, and 80 g were tested with motions including swaying, swirling, and shaking. Initial data were captured with a single contact microphone to record impact vibrations experienced by a user holding the vessel. Subsequent experiments added a second microphone to capture spatial variations, as illustrated in FIGS. 6 and 7. Recorded signals were then used to shape actuation patterns, vibration timing, and output duration of vibrotactile motors 510 integrated into fluid emulation framework 170.

FIGS. 6A, 6B, and 6C depict acoustic vibration samples of liquid motion within different vessels captured as digital audio signals using contact microphone 620. Each waveform trace 625 represents a sample of transient vibration produced by fluid impacts on vessel surfaces when the container is moved under controlled conditions. Each sample has a duration of approximately 400 ms and is displayed on a uniform amplitude scale, allowing comparisons across vessel types, motion categories, and fluid quantities.

FIG. 6A illustrates results for water bottle 605 equipped with contact microphone 620, in accordance with aspects of the disclosure. Three fluid quantities 695 of 20 g, 50 g, and 80 g were tested. Waveform traces 625 are shown for three corresponding motion type labels: sway 630A, swirl 630B, and shake 630C. Sway 630A for 20 g shows a sharp single transient, whereas higher quantities of 50 g and 80 g exhibit multiple overlapping pulses of lower amplitude, reflecting distributed impacts across water bottle 605. Swirl 630B produces extended low-amplitude oscillations, consistent with circular motion of fluid inside water bottle 605. Shake 630C generates higher amplitude sequences, with 50 g and 80 g producing more pronounced bursts than 20 g, reflecting increased fluid inertia.

FIG. 6B illustrates results for metal cup 610 with contact microphone 620, in accordance with aspects of the disclosure. Fluid quantities 695 of 20 g, 50 g, and 80 g were tested in the same manner. Sway 630A signals show sharp, high-frequency spikes relative to water bottle 605 due to the rigid metallic surface of metal cup 610. Swirl 630B signals exhibit a mixture of oscillatory motion with small impulsive peaks as fluid sloshes against the conductive metal wall. Shake 630C results are more clustered and sharper than in water bottle 605, demonstrating that the higher stiffness of metal cup 610 transmits more direct vibration energy into contact microphone 620. Waveform traces 625 highlight differences in amplitude and frequency characteristics across fluid quantities 695.

FIG. 6C illustrates results for glass flask 615 with contact microphone 620, in accordance with aspects of the disclosure. Fluid quantities 695 of 20 g, 50 g, and 80 g were again tested under the three motion type labels. Sway 630A signals for glass flask 615 reveal more resonant, sinusoidal waveforms relative to the sharper traces in water bottle 605 and metal cup 610. Swirl 630B signals for 50 g and 80 g show extended oscillatory tails with multiple peaks, indicating resonance effects within the glass body of glass flask 615. Shake 630C signals produce large, smooth pulses that vary in shape and intensity with fluid quantity 695, suggesting that the material and shape of glass flask 615 amplify lower frequency components while damping sharp transients. Waveform traces 625 from glass flask 615 demonstrate distinct spectral qualities compared to water bottle 605 and metal cup 610, highlighting how vessel material and geometry alter vibroacoustic characteristics.

Together, FIGS. 6A, 6B, and 6C demonstrate that vessel type, fluid quantity 695, and motion type labels 630A-C all influence the acoustic and vibrational properties captured by contact microphone 620. These experimental results provide baseline measurements used for shaping vibrotactile actuation patterns within fluid emulation framework 170. Differences between waveform traces 625 highlight how material stiffness, wall thickness, and geometry of vessels contribute to distinct response signatures. These differences are utilized for modeling and playback of realistic haptic responses within physical vessel 525 of fluid emulation hardware 520 as shown in FIG. 5.

FIGS. 7A, 7B, and 7C depict acoustic vibration samples of liquid interaction events captured using two contact microphones 720 mounted on opposing surfaces of different physical containers, in accordance with aspects of the disclosure. Each waveform trace 725 corresponds to a digital audio signal representing impact vibrations from water interacting with container walls during discrete motion sequences. FIG. 7A corresponds to water bottle 705, FIG. 7B corresponds to metal cup 710, and FIG. 7C corresponds to glass flask 715. In each case, three fluid quantities 795 were tested, specifically 20 g, 50 g, and 80 g of water. Each condition was further tested across three motion classes, sway 730A, swirl 730B, and shake 730C. The waveform traces 725 are plotted on a common time base of 400 milliseconds with identical amplitude scaling, enabling cross-comparison of magnitude and temporal patterns across vessels, quantities, and actions.

The acoustic signals in FIG. 7A-7C were acquired using a Tascam US-2×2 audio/MIDI interface with 24-bit resolution at a 44.1 kHz sample rate, coupled with the open-source Audacity software environment for capture and visualization. Each contact microphone 720 was secured using elastic adhesive strips to provide stable coupling to the container wall. The dual-microphone configuration provided spatial sensitivity to liquid impact events, with one microphone typically receiving higher amplitude responses when fluid directly impacted its side. By contrast, the opposite microphone often recorded attenuated or delayed responses, providing information on the asymmetry of fluid motion within the vessel. The acoustic response varied strongly as a function of container material, with water bottle 705 exhibiting relatively damped, low-frequency responses, metal cup 710 exhibiting sharper and higher-frequency resonances, and glass flask 715 exhibiting smoother but more resonant low-frequency oscillations.

Processing of these signals revealed consistent patterns. In trials for sway 730A, waveform traces 725 showed distinct peaks localized to one side of the container, corresponding to unilateral fluid impact. In swirl 730B conditions, repetitive cyclic impacts were visible, reflecting rotational fluid momentum interacting with container walls in a periodic manner. In shake 730C conditions, amplitude responses tended to balance across both microphones 720, producing similar magnitudes across opposing sides of the containers, reflecting the turbulent, multi-directional nature of shaking-induced liquid motion. Across conditions, the observed duration of individual impact events averaged 90.75 milliseconds. This measurement was established as a baseline from the single-microphone signals reported in FIG. 6A-6C and then validated using the two-microphone configuration in FIG. 7A-7C.

Using these empirical durations, fluid emulation framework 170 was configured to synthesize vibrotactile motor actuation with durations of approximately 80 milliseconds per event. The reduction from the measured 90.75 milliseconds to 80 milliseconds was informed by iterative testing, optimizing for perceptual clarity and comfort during rapid motion sequences. Fluid emulation framework 170 executes these actuation commands through processor-driven control logic interfacing with vibrotactile motors 510 (see FIG. 5). The system executes Unity-based control loops in real time, integrating signal processing results with Unity physics simulations powered by Obi Fluid to deliver synchronized haptic feedback. Memory structures within fluid emulation framework 170 store both the raw contact microphone 720 signals and the processed impact templates, while the system's network interface supports data exchange with external analysis stations. The hardware power source supplies sufficient current to maintain reliable vibration intensity across repeated trials.

Analysis of FIG. 7A-7C demonstrates the effect of fluid quantity 795 on waveform traces 725. At 20 g, responses show lower overall amplitude but clearer impulse onsets, suggesting discrete impacts with reduced inertia. At 50 g, impacts exhibit increased amplitude with broader frequency content, reflecting greater momentum transfer and container resonance. At 80 g, amplitudes are highest, with waveforms often overlapping to form complex multi-peak signatures, particularly in shake 730C trials where turbulent motion dominates. These differences in temporal and spatial patterns informed decisions on mapping vibration intensity and duration within fluid emulation framework 170, providing realistic rendering of both gentle and vigorous liquid motions.

Two sets of user studies were conducted based on the results of FIG. 7A-7C. In the exploratory study, parameters of fluid emulation framework 170 such as distance thresholds, acceleration thresholds, and vibration duration were systematically varied to observe user perception changes. In the perceptual study, the system's performance was compared to real liquid containers and static haptic proxies. A total of 16 users participated, aged 18 to 45, including individuals identifying as male, female, nonbinary, and one preferring not to specify. Four users reported no prior experience with virtual reality. Participants engaged with both single-microphone and dual-microphone derived haptic feedback, reporting that the dual-microphone mappings produced more realistic sensations of directional liquid motion. The studies confirmed that the two-microphone approach represented in FIG. 7A-7C improved the spatial realism of haptic rendering by enabling asymmetrical vibration cues during sway 730A and swirl 730B, while confirming the appropriateness of symmetrical vibration activation for shake 730C.

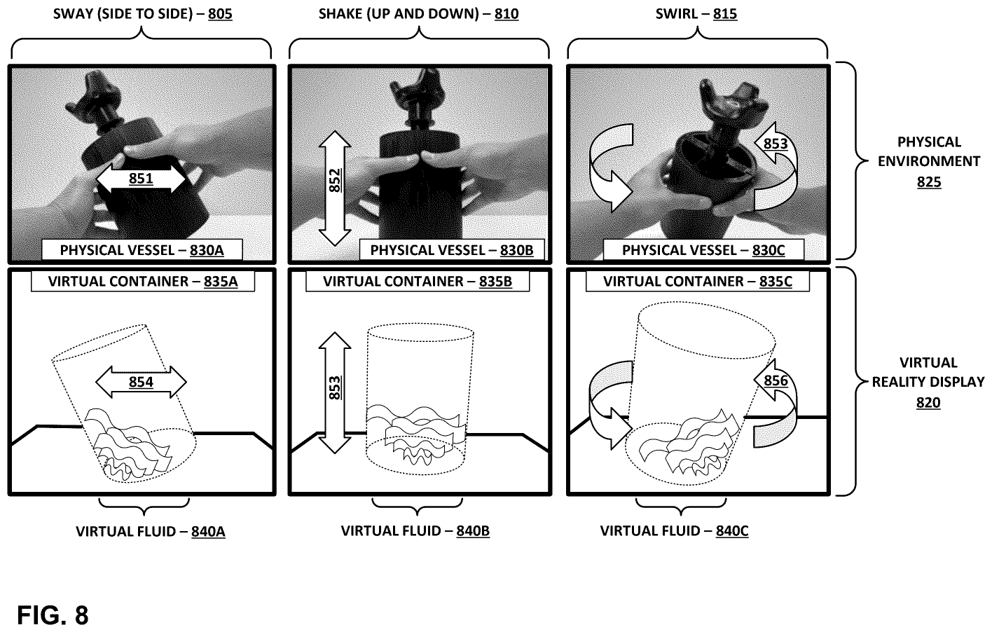

FIG. 8 depicts user interactions, in accordance with aspects of the disclosure. In particular, the user interactions depicted include sway 805, shake 810, and swirl 815 performed within physical environment 825 using physical vessel 830A, physical vessel 830B, and physical vessel 830C, respectively. Each interaction is represented within virtual reality display 820, which includes virtual container 835A, virtual container 835B, and virtual container 835C. Virtual container 835A includes virtual fluid 840A, virtual container 835B includes virtual fluid 840B, and virtual container 835C includes virtual fluid 840C. Motion arrows 851-856 indicate the directions of user interactions including side-to-side sway, vertical shaking, and circular swirling. Physical environment 825 therefore corresponds to virtual reality display 820 such that detected motion of physical vessel 830A, physical vessel 830B, and physical vessel 830C results in updating positions of virtual container 835A, virtual container 835B, and virtual container 835C and associated virtual fluid 840A, virtual fluid 840B, and virtual fluid 840C.

In exploratory user studies, emphasis was directed towards comprehensively evaluating fluid emulation framework 170, with a specific focus on configurable parameters including motor density, direct touch, and vibration strength. For each parameter exploration, users were asked to perform sway 805 using physical vessel 830A, shake 810 using physical vessel 830B, and swirl 815 using physical vessel 830C three times each, as shown in FIG. 8. Users were encouraged to interact with physical environment 825 and virtual reality display 820 for a duration of one minute. Parameter variation was randomized for each user. Participants provided feedback on their individual experiences by answering Virtual Reality Usability Evaluation (VRUSE) questions.

VRUSE is designed for assessing usability of virtual reality systems. The VRUSE questions evaluate user experience by focusing on various factors that influence interactions with virtual reality technology and typically cover aspects such as system control, ease of use, user comfort, and overall user experience in a virtual environment.

Derived from the VRUSE questionnaire, Q68 asks: “I had the right level of control over the system,” Q48 asks: “The system behaved in a manner that I expected,” Q8 asks: “I found the system easy to use,” and Q98 asks: “I would be comfortable using this system for long periods of time.” Additionally, participants were asked open-ended questions to describe their experience.

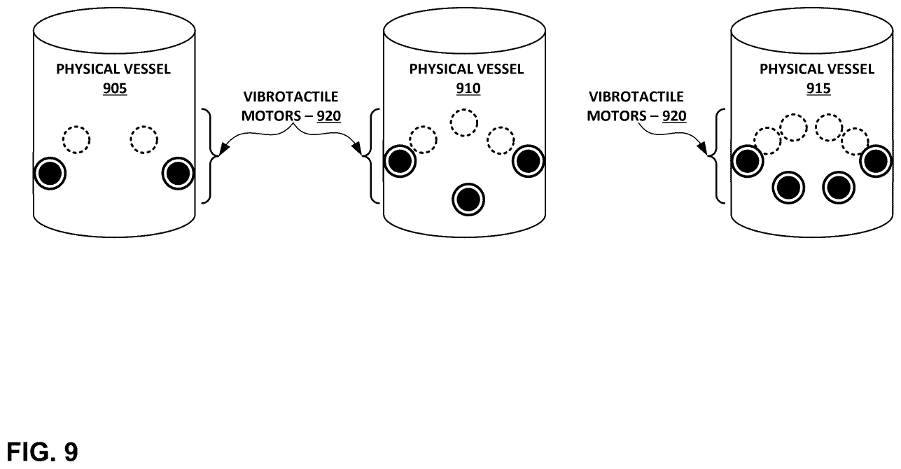

FIG. 9 depicts physical vessel 905, physical vessel 910, and physical vessel 915, each configured with different numbers of vibrotactile motors 920 to illustrate varying motor densities, in accordance with aspects of the disclosure. Physical vessel 905 includes vibrotactile motors 920 positioned to provide a total of four active vibration points. Physical vessel 910 includes vibrotactile motors 920 positioned to provide a total of six active vibration points. Physical vessel 915 includes vibrotactile motors 920 positioned to provide a total of eight active vibration points.

The distribution of vibrotactile motors 920 within physical vessel 905, physical vessel 910, and physical vessel 915 can be varied to adjust tactile resolution and haptic realism. For example, increasing motor density from four to eight vibrotactile motors 920 allows more spatially localized output that corresponds to finer variations in simulated fluid motion. Conversely, reducing motor density to four vibrotactile motors 920 reduces weight and power consumption, enabling simplified physical vessel configurations.

Each vibrotactile motor 920 may be implemented as a coin-type or linear resonant actuator controlled by processor-executed pulse width modulation signals. Motor drive signals may be varied in amplitude, duty cycle, and activation duration to generate temporally asymmetric vibration effects. The selected motor density can therefore affect the granularity of perceived directionality, intensity variation, and distribution of vibration across the surface of physical vessel 905, physical vessel 910, and physical vessel 915.

In certain implementations, physical vessel 905, physical vessel 910, and physical vessel 915 are integrated into the larger system architecture described with respect to FIG. 1. For instance, processor(s) 102 and vibrotactile actuator(s) controller 180 may receive fluid motion parameters calculated by fluid physics engine 195 and route corresponding drive signals to vibrotactile motors 920 in accordance with the chosen motor density. Memory 104 and storage device(s) 108 may store configuration data defining the number of vibrotactile motors 920 and mapping between virtual fluid positions and motor activation patterns. Network interface 106 may transmit experimental data regarding motor density performance for evaluation in user studies. User interface 110 may allow a developer to adjust motor density configurations through configuration settings 196.

Through these arrangements, FIG. 9 illustrates how the physical design of physical vessel 905, physical vessel 910, and physical vessel 915 can be varied by altering the number of vibrotactile motors 920, thereby modifying the balance between physical weight, power requirements, and fidelity of haptic sensation in virtual reality display 820.

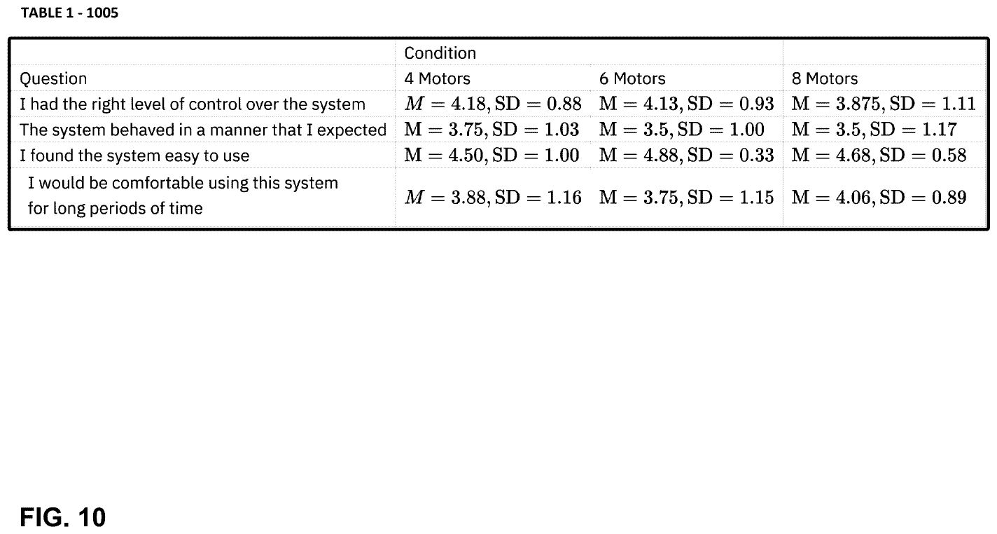

FIG. 10 depicts table 1, shown as element 1005, providing user rating scores for motor density conditions including four motors, six motors, and eight motors in accordance with aspects of the disclosure. Table 1 illustrates mean values and standard deviations for responses to selected Virtual Reality Usability Evaluation (VRUSE) questions. The questions included: “I had the right level of control over the system,” “The system behaved in a manner that I expected,” “I found the system easy to use,” and “I would be comfortable using this system for long periods of time.”

Motor density: In this user study, the influence of motor density on haptic sensation was investigated, specifically focusing on the number of vibrotactile motors within the system and the associated spatial patterns. The key questions guiding this exploration centered on understanding how varying the number of motors, specifically four, six, or eight, arranged along the side of a three-dimensional printed container impacted the overall haptic experience. Each motor density corresponded to physical vessel 905, physical vessel 910, or physical vessel 915 as previously illustrated in FIG. 9.

RESULTS: Participants reported discrepancies in feedback intensity and timing, particularly when comparing motions such as shaking, swirling, and swaying. Some motions elicited strong and immediate vibrotactile responses, while others produced weaker or delayed sensations, which reduced the perceived realism of the simulated fluid. These discrepancies are reflected in table 1 of FIG. 10, element 1005, with no single motor density condition demonstrating consistent superiority across all VRUSE categories.

Qualitative feedback further illustrated subjective impressions of haptic realism. In the four-motor condition corresponding to physical vessel 905, four participants likened the haptic feedback to beans in a container, while another described the sensation as particle dots. In the six-motor condition corresponding to physical vessel 910, one participant mentioned beans, while three described the sensation as similar to slime or gel. In the eight-motor condition corresponding to physical vessel 915, one participant compared the sensation to liquid and beans, while two participants described it as resembling liquid sloshing in a container. These testimonials indicated that higher motor density correlated with a perception of increased liquidity and smoother transitions in haptic feedback.

The results summarized in table 1, element 1005, therefore demonstrate that user perception of virtual fluid realism is sensitive to motor density. Integration of four, six, or eight vibrotactile motors allows different trade-offs between weight, power consumption, and haptic fidelity, as implemented within the broader system architecture described with respect to FIG. 1.

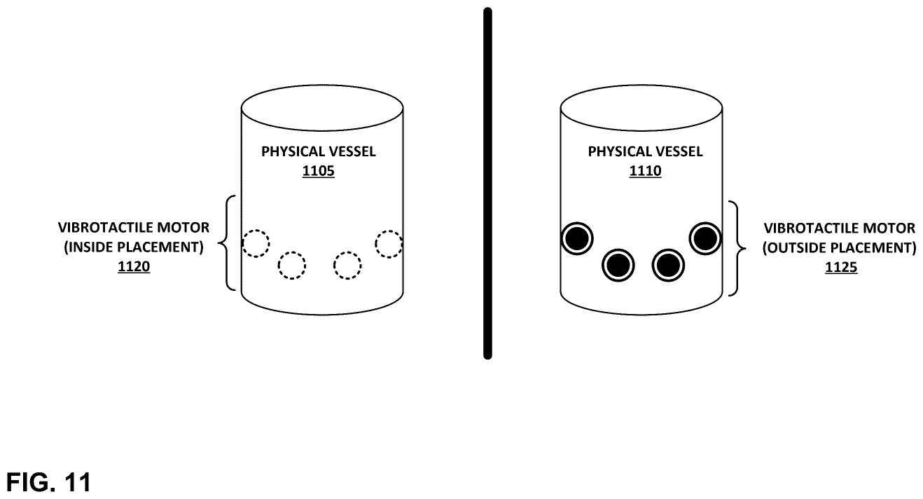

FIG. 11 depicts a comparative frontal view of physical vessel 1105 and physical vessel 1110 illustrating two alternative motor placement configurations in accordance with aspects of the disclosure. Physical vessel 1105 includes vibrotactile motor (inside placement) 1120, where the vibrotactile motors are arranged along an interior surface of the vessel and are represented schematically in dashed outline to indicate their internal positioning. Physical vessel 1110 includes vibrotactile motor (outside placement) 1125, where the vibrotactile motors are mounted on the exterior surface of the vessel and are shown in solid outline.

The arrangement shown in FIG. 11 was used in user studies to evaluate the effect of direct touch on perceived haptic feedback. In the configuration of physical vessel 1105 with vibrotactile motor (inside placement) 1120, the motors directly contacted the user's hand through the vessel wall, allowing vibration to be transmitted through the vessel material with minimal attenuation. In contrast, in the configuration of physical vessel 1110 with vibrotactile motor (outside placement) 1125, the motors were positioned externally, resulting in an indirect transmission path of vibrations through the vessel surface before reaching the user's hand.

Participants reported that vibrotactile motor (inside placement) 1120 in physical vessel 1105 generally created a more pronounced and sharper haptic sensation compared to vibrotactile motor (outside placement) 1125 in physical vessel 1110, which tended to produce a diffused or dampened sensation. This observation suggests that placement of the vibrotactile motors can significantly alter the fidelity of perceived feedback. The experimental outcomes further indicated that direct tactile coupling between the user's hand and the active surface of vibrotactile motor (inside placement) 1120 increased the realism of fluid emulation when compared with vibrotactile motor (outside placement) 1125.

These results support the conclusion that the spatial positioning of vibrotactile motor (inside placement) 1120 and vibrotactile motor (outside placement) 1125 relative to physical vessel 1105 and physical vessel 1110 respectively may be used as a tunable parameter within the overall fluid emulation framework. This allows system designers to balance tradeoffs between ease of assembly, durability, and perceptual strength of haptic feedback in different application contexts.

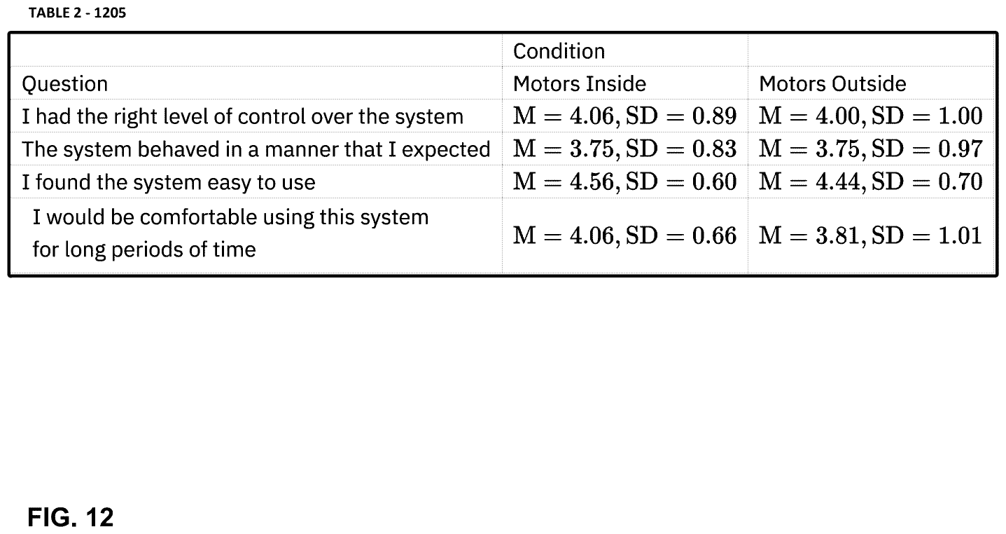

FIG. 12 depicts Table 2, set forth at element 1205, providing user rating scores for the direct touch conditions, including configurations with vibrotactile motor inside placement 1120 and vibrotactile motor outside placement 1125 mounted on physical vessel 1105 and physical vessel 1110 respectively, in accordance with aspects of the disclosure. The study presented by Table 2 builds directly upon the structural configurations illustrated in FIG. 11, where vibrotactile motors were selectively arranged inside versus outside the 3D printed container, thereby altering the tactile interaction between user and device.

Direct touch: In this user study, the exploration extends to user perception of direct tactile feedback, which is distinct from mediated vibrations transmitted through material layers. The objective was to determine the effect on immersion and control when users interacted with vibrotactile motor inside placement 1120 as compared to vibrotactile motor outside placement 1125. The key question guiding this study was how tactile cues differ when filtered through the wall of physical vessel 1105 versus experienced through direct skin contact with motors affixed to physical vessel 1110. This contrast allowed researchers to investigate not only the fidelity of the haptic signal but also how material mediation versus direct motor exposure influences presence and realism.

RESULTS: An examination of user rating scores from Table 2, set forth at FIG. 12, element 1205, indicates that vibrotactile motor inside placement 1120 yielded marginally higher average scores than vibrotactile motor outside placement 1125 across three of the four rating dimensions. This quantitative difference suggests that vibration mediated through the wall of physical vessel 1105 may produce a smoother or more immersive sensation than direct contact with exposed motors. However, preferences were not uniform, and both positive and negative experiences were reported depending on motor placement.

With vibrotactile motor outside placement 1125, several participants favored the more distinct tactile signature. One participant, User 5, remarked, “As opposed to what I felt in the previous version, this felt more comfortable due to a more pronounced feel of the motors being outside.” This perspective aligns with the hypothesis that direct skin contact can heighten salience of vibrotactile events. However, immersion trade-offs were also reported. User 16 stated, “The container used with the wires broke the immersion a bit for me because it didn't feel like the object I was holding in VR. It created a disconnect for me. If the 3D object had wires, then maybe it would have been more immersive and less of a disconnect.” Such commentary highlights the complex interplay between tactile fidelity and congruence of physical and virtual objects.

When the vibrotactile motor inside placement 1120 was used, other participants reported stronger immersion. User 16 contrasted the inside placement with the outside placement, explaining, “As I moved the device around, the liquid moved and the device was very responsive. This was more accurate and created a better, and more immersive, experience overall.” User 13 corroborated this view, noting, “I felt that vibrations in this trial matched my movements the best.” These statements suggest that, while the intensity of the vibration was somewhat attenuated by the container wall of physical vessel 1105, the overall temporal correspondence between motor actuation and virtual fluid motion may have been enhanced, leading to higher ratings of control and realism.

Taken together, the findings reported in Table 2, element 1205, demonstrate that user preference tilted slightly toward the vibrotactile motor inside placement 1120. However, both configurations offered unique experiential qualities: outside placement increased salience but risked breaking immersion, while inside placement offered a more cohesive but somewhat dampened tactile signal. This duality underscores the importance of considering not only motor density and strength, but also placement, material mediation, and perceptual congruence when designing physical-to-virtual haptic feedback systems.

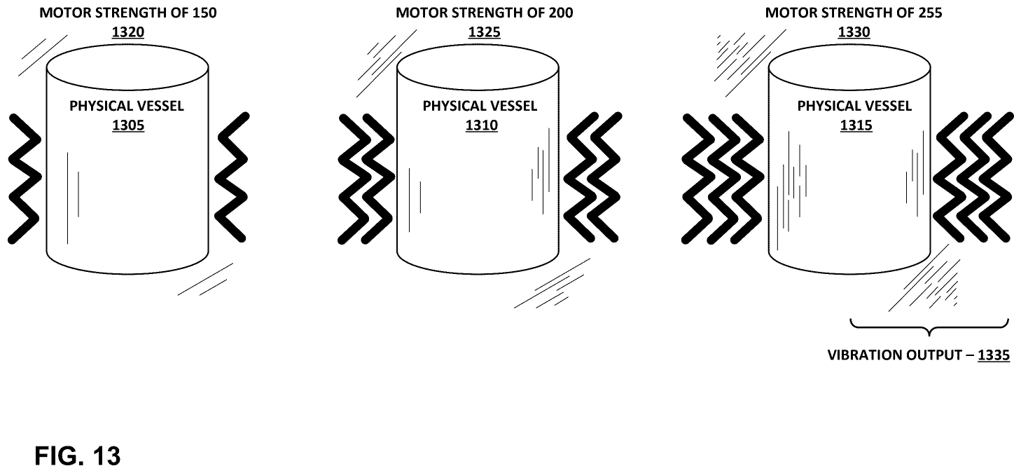

FIG. 13 depicts a frontal view of physical vessel 1305, physical vessel 1310, and physical vessel 1315 configured to operate at different motor strength conditions, in accordance with aspects of the disclosure. Motor strength of 150 is indicated at element 1320, motor strength of 200 is indicated at element 1325, and motor strength of 255 is indicated at element 1330. Each of physical vessel 1305, physical vessel 1310, and physical vessel 1315 outputs corresponding vibration output 1335, with the amplitude of vibration output 1335 proportional to the assigned motor strength condition. FIG. 13 thus provides a comparative representation of how vibration output 1335 is experienced across different levels of motor drive intensity.

In exploratory user studies, the parameter of vibration strength was systematically varied alongside other parameters such as motor density and direct touch, as part of the broader evaluation of fluid emulation framework 170. For this investigation, participants were asked to perform the sway, shake, and swirl actions described with respect to FIG. 8 while interacting with physical vessel 1305, physical vessel 1310, and physical vessel 1315. Each motor strength condition was randomized to reduce order effects. The intent was to capture not only subjective impressions of realism and immersion, but also the degree to which vibration output 1335 mapped onto user expectations of fluid motion inside a container.

Participants reported that lower motor strength, such as motor strength of 150 at element 1320, was frequently perceived as subtle or muted, evoking sensations of lighter or less viscous fluids. Conversely, higher motor strength, such as motor strength of 255 at element 1330, was experienced as more forceful and occasionally overwhelming, with several participants likening it to turbulent sloshing or heavy liquid impact. Motor strength of 200 at element 1325 was generally described as a balanced condition, with some users indicating that this level of vibration output 1335 provided the best match to their expected fluid dynamics when swaying or swirling the vessel.

Representative user comments highlight these perceptions. One participant described the motor strength of the 150 condition as “like water barely moving around in a container—gentle but not fully convincing.” Another user noted that the motor strength of 200 felt “felt natural, almost like an actual glass of liquid moving with my motions.” In contrast, a participant described the motor strength of 255 condition as “jarring at times, like the container was overfilled and sloshing violently.” These varied impressions underscore the role of vibration output 1335 in shaping the immersive quality of the experience and suggest that user preference may vary according to task context, individual sensitivity, and desired realism.

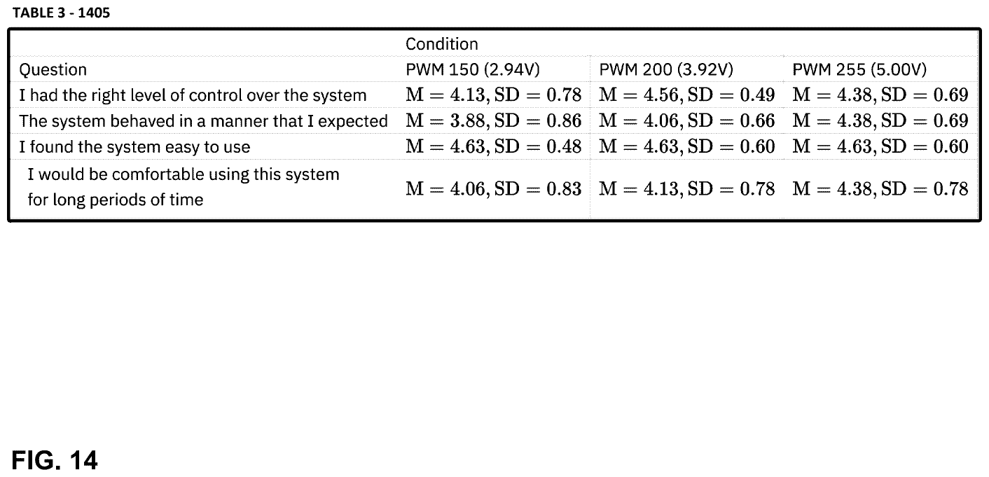

FIG. 14 depicts Table 3, set forth at element 1405, providing user rating scores for motor strength conditions corresponding to motor strength of 150 at physical vessel 1305, motor strength of 200 at physical vessel 1310, and motor strength of 255 at physical vessel 1315, in accordance with aspects of the disclosure. Each motor strength condition is driven by a corresponding pulse width modulation (PWM) setting, including PWM 150 at 2.94 V, PWM 200 at 3.92 V, and PWM 255 at 5.00 V.

Motor strength: This section examines the effect of vibration strength on user experience in direct haptic interaction with the physical vessel. The objective involves understanding how variation in motor strength influences the magnitude, clarity, and realism of tactile feedback during system use. The user study presented in FIG. 14 focuses on comparing lower-intensity vibration feedback associated with motor strength of 150, medium-intensity vibration feedback associated with motor strength of 200, and higher-intensity vibration feedback associated with motor strength of 255.

RESULTS: Table 3, set forth at FIG. 14, element 1405, demonstrates that motor strength of 255 at physical vessel 1315 achieved higher user ratings than motor strength of 150 at physical vessel 1305 or motor strength of 200 at physical vessel 1310 for multiple questions, particularly with respect to comfort during prolonged use and overall control perception. While motor strength of 200 also performed well, user feedback suggested that the higher intensity condition provided stronger immersion.

User testimonials further illuminate variation across motor strength conditions. In the motor strength of 150 condition at physical vessel 1305, User 11 remarked, “Felt like there was moving liquid. The vibration didn't feel too strong, but that made it feel more realistic.” Conversely, User 16 expressed dissatisfaction, stating, “Sometimes I could not feel any vibration when there should be one. This broke the immersion a bit. When we had the previous version with the strong vibrations, I was sure to feel everything since it was strong.” In contrast, motor strength of 200 at physical vessel 1310 and motor strength of 255 at physical vessel 1315 were often described as producing sensations that were more consistent, with feedback intensity aligning more reliably with user actions.

Several participants associated particular motor strength levels with specific material properties. For the motor strength of 150 at physical vessel 1305, two users described the sensation as resembling beans in a container, while another referenced a “mechanical movement feeling,” and two additional participants compared the feedback to that of a smartphone vibration. In the motor strength of 200 condition at physical vessel 1310, one participant likened the sensation to soft foam, while others compared it to beads or beans. In the motor strength of 255 condition at physical vessel 1315, three participants associated the sensation with beans, while another compared the feedback to vibrations produced by a game station controller. Other participants described the haptic sensation across conditions as comparable to the movement of liquid within a vessel.

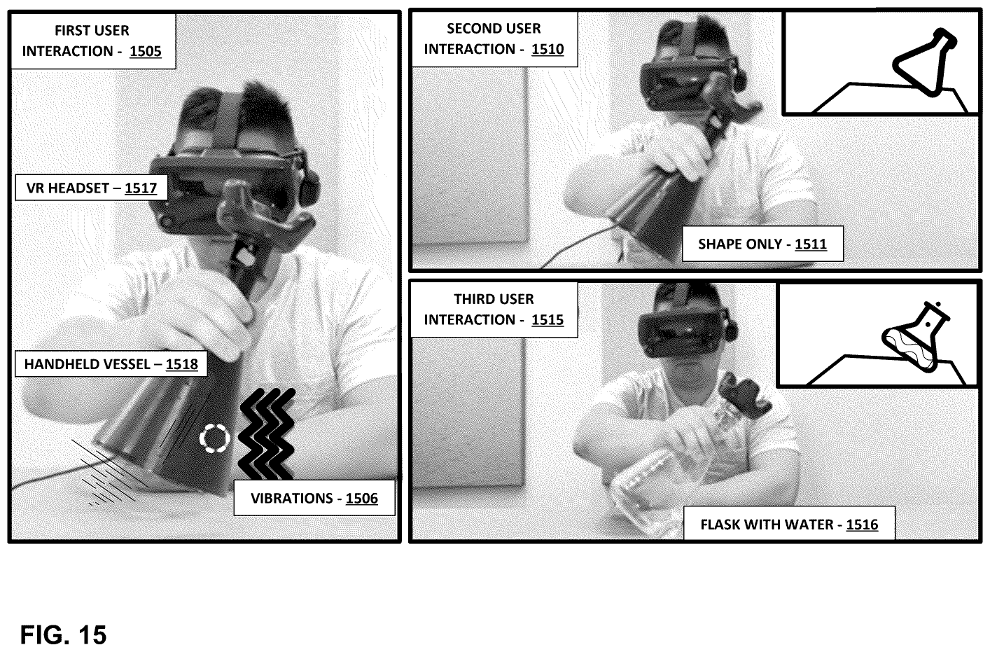

FIG. 15 depicts a sequence of user trials highlighting differing interaction modalities with fluid emulation framework 170, in accordance with aspects of the disclosure. First user interaction 1505 illustrates a participant wearing VR headset 1517 while holding handheld vessel 1518 and receiving vibrotactile feedback through vibrations 1506 generated by vibrotactile motors mounted within the system. The participant perceives fluid-like dynamics through vibration output mapped to motion of handheld vessel 1518, providing a proxy for liquid motion within a container.

Second user interaction 1510 depicts the participant again wearing VR headset 1517 and manipulating handheld vessel 1518 under a shape-only condition 1511. In this mode, handheld vessel 1518 provides only a static proxy of the container geometry without vibratory haptic effects. Virtual rendering within VR headset 1517 presents the container geometry alone, decoupled from any physical liquid dynamics, thereby isolating the impact of visual and geometric cues on user immersion.

Third user interaction 1515 depicts the participant holding flask with water 1516, an Erlenmeyer flask containing approximately 80 g of real liquid, while simultaneously observing the virtual proxy in VR headset 1517. This condition enables a direct comparison between actual fluid mass and momentum transfer with the simulated liquid dynamics provided by vibrations 1506 in prior interactions. Flask with water 1516 thus provides a baseline for evaluating how closely vibrotactile feedback in handheld vessel 1518 aligns with real-world liquid behavior.

Together, first user interaction 1505, second user interaction 1510, and third user interaction 1515 provide three controlled experimental conditions—vibration-based haptic feedback, geometry-only static proxy, and physical liquid baseline. This triad of test conditions enables systematic evaluation of the efficacy of fluid emulation framework 170 in reproducing user perception of real-world liquids under immersive VR scenarios.

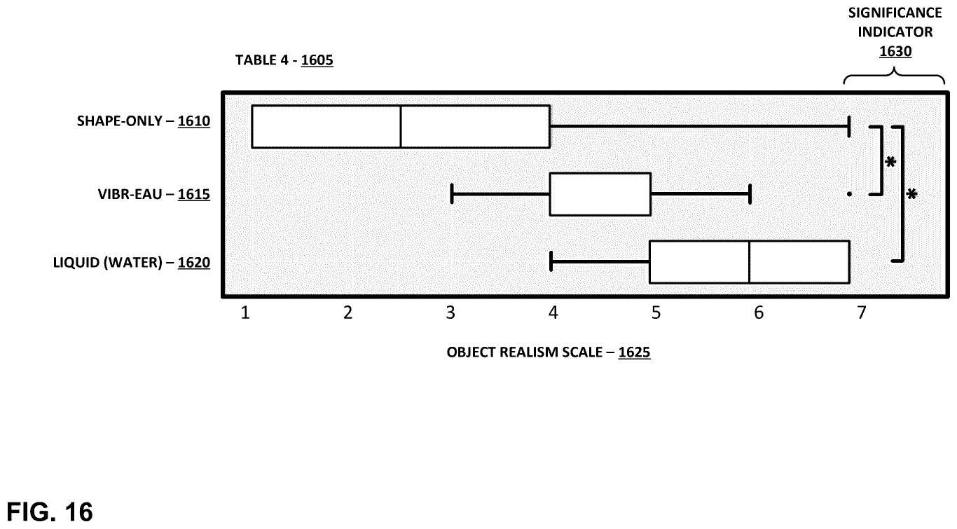

FIG. 16 depicts table 4 1605 providing object realism scores for shape-only 1610 static haptic proxy, vibr-eau 1615 fluid emulation framework with vibrations, and liquid (water) 1620 in a flask, in accordance with aspects of the disclosure. Object realism was assessed using object realism scale 1625, and statistical significance is indicated by significance indicator 1630 marked by an asterisk.

Perceptual user study: In the perceptual user studies, the objective involved evaluating the performance of vibr-eau 1615 fluid emulation framework 170 providing vibrations against liquid (water) 1620 and shape-only 1610 static haptic proxies while assessing its generalization of fluid emulation framework 170 across various vessel profiles. Based on feedback from the exploration user study, a decision emerged to use eight motors, positioned inside the 3D printed vessel, with a vibration strength of 255 as the parameters for the perceptual study. For each condition and vessel shape, users performed three actions, sway (side to side), shake (up and down), and swirl (around the vertical axis), as shown in FIG. 8. Users engaged with vibr-eau 1615 fluid emulation framework 170 providing vibrations for one minute. Conditions and vessel shapes were randomized for each participant. Feedback collected utilized object realism scale 1625, structured as a 7-point Likert scale, alongside open-ended questions to capture individual experiences. Data analysis employed Tukey's HSD for conducting pairwise comparisons to determine statistical significance in the means of object realism, illustrated in FIG. 16 by significance indicator 1630. Notable user responses are also shared.

Baseline comparisons: The experiment evaluated the haptic sensations provided by vibr-eau 1615 fluid emulation framework 170 within an Erlen vessel shape compared to two baselines: shape-only 1610 haptic proxy represented by an identical-shaped vessel without vibrations, and liquid (water) 1620 in a 1000 ml Erlenmeyer flask filled with 80 g of water (405 g+95 g Vive tracker). These conditions are illustrated in FIG. 16. Based on the object realism results set forth in table 4 1605, it was concluded that vibr-eau 1615 fluid emulation framework 170 providing vibrations can achieve a level of object realism comparable to that of liquid (water) 1620.

RESULTS: Users rated both vibr-eau 1615 fluid emulation framework 170 (M=4.9, SD=1.0) and liquid (water) 1620 (M=5.9, SD=1.1) highly regarding object realism. In contrast, users found shape-only 1610 (M=2.75, SD=1.7) unconvincing. No statistically significant difference existed between the means of vibr-eau 1615 and liquid (water) 1620 (Q=2.95, P=0.1). Statistically significant differences were observed between vibr-eau 1615 and shape-only 1610 (Q=6.28, P<0.01), as well as between liquid (water) 1620 and shape-only 1610 (Q=9.23, P<0.01). The distribution of data appears in FIG. 16 through table 4 1605 and object realism scale 1625. Interaction modalities for these conditions are depicted in FIG. 15.

Nine out of sixteen users perceived a weight shift when using vibr-eau 1615 fluid emulation framework 170 indicating successful emulation of the dynamic mass of virtual fluids through vibrations. User 14 stated, “I was overall able to feel a shift in weight when slowly and aggressively tilting the object.” User 3 noted, “I was able to feel the weight change, more when I was swaying the beaker's lower section than when I shook the top.” Although vibr-eau 1615 successfully emulated the weight shift of virtual liquids for some users, six users encountered inconsistencies in the system's response, reporting instances where expected motions failed to trigger vibrations or where vibrations were anticipated but not felt during interactions.

In liquid (water) 1620 provided by third user interaction, the majority of participants (14 out of 16) reported perceiving a weight shift while interacting with the real liquid. Six users expressed dissatisfaction, noting discrepancies between the behavior of liquid (water) 1620 and their expectations based on the virtual simulation. User 9 elaborated, “Honestly, the only thing that seems off is that the liquid does not seem to share the same consistency/viscosity as the virtual liquid.”

In shape-only 1610 of second user interaction, only two out of sixteen users perceived a weight shift, possibly due to visual illusions. Most participants reported not feeling any haptic feedback.

Overall, users found interacting with vibr-eau 1615 fluid emulation framework 170 compelling. User 11 stated, “When comparing this to an actual flask with liquid, it's a lot more realistic than I expected.” User 4 noted, “The gradual weight shift and apt haptic sensation produced by vibr-eau 1615 were on par [with liquid] and provided real feedback for holding a vessel with fluid in it.” User 10 remarked, “I liked the representation of vibr-eau 1615 because it felt as if I was experiencing the ‘liquid’ in VR, which may represent an innovative approach to implement in the realm of virtual reality.”

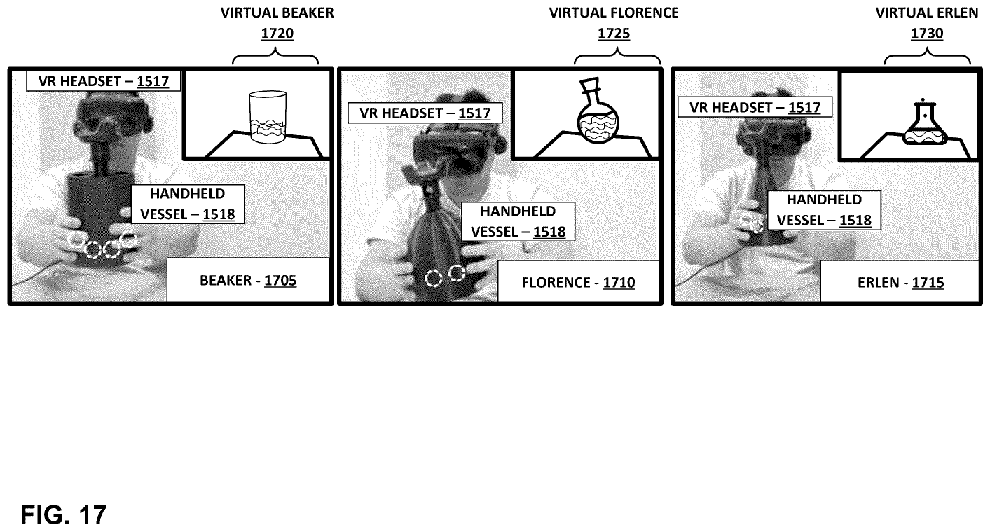

FIG. 17 depicts a user wearing VR headset 1517 and engaging with handheld vessel 1518 across three representative vessel conditions, including beaker 1705, Florence 1710, and Erlen 1715, in accordance with aspects of the disclosure. Each of these physical vessel profiles corresponds to a virtual rendering of the same vessel, including virtual beaker 1720, virtual Florence 1725, and virtual Erlen 1730, which are displayed in synchronization with the user's physical interactions. The circles shown on handheld vessel 1518 in each condition highlight vibrotactile motors of fluid emulation framework 170 that are activated during user engagement with the vessel.

The interaction shown with beaker 1705 includes simultaneous representation of virtual beaker 1720, with vibrotactile motors on handheld vessel 1518 activated to emulate the distribution of virtual fluid mass within the cylindrical profile. In the condition with Florence 1710, virtual Florence 1725 is rendered, and handheld vessel 1518 activates vibrotactile motors to simulate both the bulbous curvature of the flask and the distribution of virtual liquid therein. For the Erlen 1715 interaction, virtual Erlen 1730 provides the corresponding digital rendering, while handheld vessel 1518 outputs vibrations aligned with the tapered triangular geometry of the flask to convey shifting liquid weight.

Across all conditions, VR headset 1517 receives input from the simulation environment and outputs visual renderings corresponding to virtual beaker 1720, virtual Florence 1725, and virtual Erlen 1730. Handheld vessel 1518 receives haptic control signals from fluid emulation framework 170 and outputs vibrotactile motor responses to the user's grip and motion. This integration of VR headset 1517, handheld vessel 1518, and the active vibrotactile motors of fluid emulation framework 170 enables concurrent visual and haptic realism for multiple vessel profiles, thereby supporting assessment of generalization of the system across different container geometries.

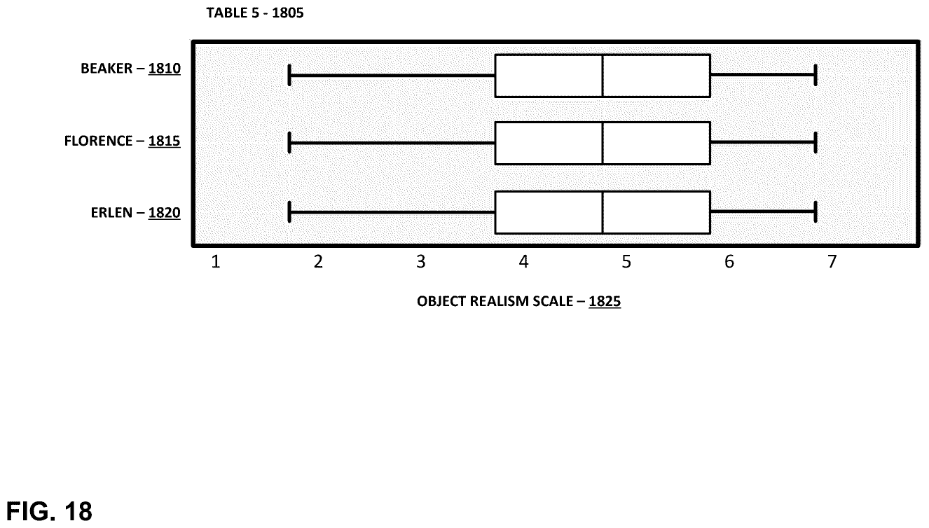

FIG. 18 depicts table 5 set forth at element 1805, providing object realism scores for vessel shapes including beaker 1810, Florence 1815, and Erlen 1820, in accordance with aspects of the disclosure.

Multiple vessels: Object realism scale 1825 spans values 1 through 7 as depicted in table 5 1805.

The experiment was expanded to encompass diverse shape profiles, namely beaker 1810 (cylinder), Florence 1815 (sphere), and Erlen 1820 (cone) vessel shapes. These shapes are shown in FIG. 17. Based on the experiment, it was concluded that the haptic feedback provided by fluid emulation framework 170 would consistently deliver the sensation of virtual fluids across different vessel shapes.

RESULTS: The means depicted by FIG. 18 for beaker 1810 (M=4.9, SD=1.4), Florence 1815 (M=4.9, SD=1.4), and Erlen 1820 (M=4.8, SD=1.2) vessel shapes were all fairly consistent. In computing Tukey's HSD, no statistical significance emerged among the pairwise comparisons. Overall, based on these scores, fluid emulation framework 170 performed similarly across different vessel shapes regarding object realism scores. The distribution of data can be seen in FIG. 18.

User experiences with haptic feedback: Users reported mixed experiences with haptic feedback, with some finding the sensations accurate and others noting inconsistencies, particularly during gentle movements. Participants perceived a weight shift for different vessel shapes: 7 out of 16 for beaker 1810, 7 out of 16 for Florence 1815, and 7 out of 16 for Erlen 1820. Different hand sizes may have impacted the user experience. User 13 states, “Overall, I think I had a preference for the other shapes compared to the sphere. The sphere I thought was too big and loose to handle comfortably. The cylinder I found better to handle than the sphere and had a better shifting of weight to it. Overall, I thought the flask to be the best.” Meanwhile, User 2 believes, “I think that the sphere seemed the best. Maybe because of the way I held it? It seemed to have the strongest likeness to the liquid in VR.” User 8 comments, “I liked the Erlen the most; it was the easiest to handle and was the most responsive. The sphere was the least responsive and the most unwieldy, and the cylinder stands somewhere in the middle.” Interactions involving one hand versus two hands, as well as the size of the vessels, contribute to the user experience, reflecting the variability observed in user responses. Overall, fluid emulation framework 170 successfully generated the haptic sensation for virtual fluids across different vessel shapes.

Dynamic weight shift perception via asymmetric vibration—spatial and temporal: The results of the study demonstrate the effectiveness of fluid emulation framework 170 in conveying dynamic weight shifts of virtual liquids through spatially and temporally asymmetric vibrations. Nearly half of the participants reported feeling sensations that closely resembled the movements and dynamic weight shifts of liquid within a container, despite the absence of physical liquid. The spatial and temporal asymmetry of the vibrations played a significant role in enhancing the realism of the haptic experience. By activating motors selectively based on the position and movements of the virtual liquid, the system created nuanced tactile sensations that aligned with user expectations of interacting with a liquid and emulated the sensation of dynamic weight shift.

Haptic rendering of fluid behavior: Qualitative feedback from participants further supports the effectiveness of fluid emulation framework 170 in simulating liquid-like sensations. Many users explicitly mentioned that the haptic feedback experienced closely resembled the tactile qualities of liquid in a container. Participants also noted that fluid emulation framework 170 was capable of rendering haptic sensations representative of other materials in the container, such as beans, beads, or foam. This indicates success in eliciting the intended perceptual responses, as users accurately recognized and interpreted the haptic sensations as representative of a liquid medium.

Improvements and future applications: User feedback also elicited suggestions for extended features of fluid emulation framework 170. Participants noted inconsistencies in the intensity and timing of haptic feedback, particularly during slow motions when the motors remained inactive. For instance, extended features of fluid emulation framework 170 may provide more responsive motor activation algorithms and fine-tuning vibration parameters to provide a consistent and immersive haptic experience.

Fluid emulation framework 170 opens up opportunities for various applications across domains such as virtual reality gaming, education, and training. By accurately replicating the tactile properties of different materials within virtual containers, fluid emulation framework 170 may enhance the realism and effectiveness of virtual simulations and training scenarios. Fluid emulation framework 170 may be extended to applications specifically configured for VR theme park settings, gaming, physical science labs, and remote learning.

In such a way, user experiences with the intensity and timing of haptic feedback across various conditions and interactions were utilized to fine-tune the configuration of fluid emulation framework 170 to provide an overall better user experience. The approach of activating motors based on predetermined acceleration thresholds and distance events, such as rapid shakes or swirls, yielded user comments regarding the perception of irregular timing of haptic feedback. Based on user input, fluid emulation framework 170 may beneficially be configured to provide a continuous scaled vibration strength approach. This approach would adjust vibration intensity based on motion speed, triggering lower intensity vibrations for slower movements and stronger vibrations for faster actions. Other custom configurations to fluid emulation framework 170 may include adjusting the parameters of the virtual fluid to prevent excessively rapid movements, which may help address this issue and enhance overall coherence between visual and tactile feedback. User perception of haptic feedback may also be influenced by the accompanying visual stimuli or the virtual environment. Such dependency on visual cues may affect the overall effectiveness of fluid emulation framework 170.

Other extensions to, and custom configuration of fluid emulation framework 170 pertain to motor placement. For instance, a circular arrangement of motors within the 3D-printed vessel was utilized for the experiment; however, other arrangements may be utilized to alter overall user perception. Still further, material type and liquid behavior may be customized by manipulating parameters such as frequency, amplitude, and waveform of motor signals to replicate tactile sensations associated with various materials. For example, adjusting frequency and intensity of vibrations using custom configurations to fluid emulation framework 170 may increase user perception of a virtual environment mimicking viscosity or density of liquids. Similarly, varying amplitude and duration of pulses to recreate the texture of solids, such as grains or beads, may alter user perception of various materials. Such changes to the configuration of fluid emulation framework 170 may enhance the realism and versatility of the system.

Multi-sensory integration: Fluid emulation framework 170 may increase user perception of immersion within the virtual environment even further through the use of audio cues, such as the sound of real liquid splashing against container walls. Fluid emulation framework 170 may therefore be extended to integrate visual and auditory cues to enhance the fidelity of material replication. Synchronizing haptic feedback with visual representations of virtual containers and their contents may create a more immersive multisensory experience. Incorporating sound effects that correspond to tactile sensations experienced may further enhance the illusion of interacting with virtual fluids.

Impact of weight: Fluid emulation framework 170 may increase user perception of immersion within the virtual environment even further through the use of configurable weights of the user interfacing apparatus. For instance, feedback from users indicated that the lightness of fluid emulation framework 170 detracted from the realism of the experience. Suggestions for increasing the weight of the vessel emerged as a potential avenue for an increased sense of immersion. Additional configuration of fluid emulation framework 170 may therefore alter the weights of objects to better coincide with real-world expectations or alter vibrotactile motor output to affect user perception of weight and movement.

In such a way, fluid emulation framework 170 enables multiple vibrotactile actuators to replicate haptic sensations of virtual fluids within a container, utilizing spatial and temporal asymmetry. Experiments demonstrate that users perceive dynamic weight shifts of virtual liquids through these asymmetric vibrations. Fluid emulation framework 170 emulates the haptic sensation of liquid nearly as effectively as physical liquid in a container, demonstrating a strong ability to generalize across different vessel shapes. Overall feedback indicates a positive response to the capability of fluid emulation framework 170 to deliver liquid-like haptic sensations. Fluid emulation framework 170 may therefore be applied to applications ranging from gaming to virtual training scenarios, each offering users a more immersive and engaging experience when interacting with virtual fluids through the use of fluid emulation framework 170.

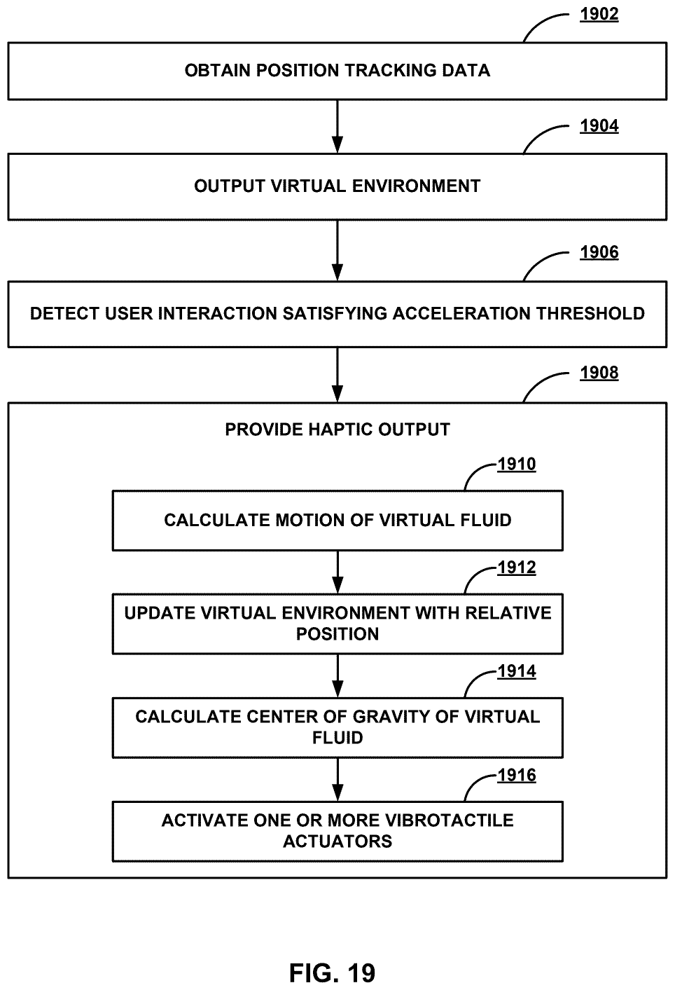

FIG. 19 is a flow diagram illustrating an example method for generating haptic feedback based on interactions with a physical vessel, in accordance with aspects of this disclosure. FIG. 19 is described with respect to computing device 100 of FIG. 1, including processor(s) 102, memory 104, and storage device(s) 108 storing fluid emulation framework 170, object tracking 190, fluid physics engine 195, and virtual reality integrator 175. However, the techniques of FIG. 19 may be performed by different components of computing device 100 or by additional or alternative systems.

Processing circuitry of computing device 100, executing object tracking 190, may be configured to obtain position tracking data (1902). For example, object tracking 190 may obtain position tracking data corresponding to a physical vessel equipped with a plurality of vibrotactile actuators arranged along an interior surface of the physical vessel.

Processing circuitry of computing device 100, executing virtual reality integrator 175, may be configured to output a virtual environment (1904). For example, virtual reality integrator 175 may output a virtual environment for display via VR output 176 to a display interface, wherein the virtual environment includes a virtual container representing the physical vessel and a virtual fluid inside the virtual container.

Processing circuitry of computing device 100, executing object tracking 190, may be configured to detect user interaction satisfying an acceleration threshold (1906). For example, object tracking 190 may analyze position tracking data to detect that a user interaction with the physical vessel satisfies an acceleration threshold.

Processing circuitry of computing device 100, executing fluid emulation framework 170, may be configured to provide haptic output (1908). For example, in response to detecting that the user interaction with the physical vessel satisfies the acceleration threshold, fluid emulation framework 170 may initiate haptic output through the plurality of vibrotactile actuators.

Processing circuitry of computing device 100, executing fluid physics engine 195, may be configured to calculate motion of virtual fluid (1910). For example, fluid physics engine 195 may calculate a motion of the virtual fluid within the virtual container using the detected user interaction with the physical vessel.

Processing circuitry of computing device 100, executing virtual reality integrator 175, may be configured to update the virtual environment with relative position (1912). For example, virtual reality integrator 175 may update the virtual environment to display a relative position of the virtual fluid based on the calculated motion.

Processing circuitry of computing device 100, executing fluid physics engine 195, may be configured to calculate center of gravity of virtual fluid (1914). For example, fluid physics engine 195 may determine a center of gravity of the virtual fluid based on the motion.

Processing circuitry of computing device 100, executing fluid emulation framework 170, may be configured to activate one or more vibrotactile actuators (1916). For example, fluid emulation framework 170 may activate one or more of the plurality of vibrotactile actuators of the physical vessel based on the calculated center of gravity.

In this way, FIG. 19 illustrates a method that coordinates object tracking 190, virtual reality integrator 175, fluid physics engine 195, and fluid emulation framework 170 to link simulated virtual fluid dynamics with physical vessel actuation. The method enhances immersion by aligning visual updates of fluid motion with spatially corresponding tactile sensations delivered through the vibrotactile actuators.

This disclosure includes the following examples.
Example 1—A method comprising: obtaining position tracking data corresponding to a physical vessel equipped with a plurality of vibrotactile actuators arranged along an interior surface of the physical vessel; outputting a virtual environment for display to a display interface, wherein the virtual environment includes a virtual container representing the physical vessel and a virtual fluid inside the virtual container; detecting, based on the position tracking data, that a user interaction with the physical vessel satisfies an acceleration threshold; and in response to detecting that the user interaction with the physical vessel satisfies the acceleration threshold, providing haptic output from the plurality of vibrotactile actuators, wherein the providing includes: calculating a motion of the virtual fluid within the virtual container using the user interaction detected with the physical vessel; updating the virtual environment to display a relative position of the virtual fluid based on the motion; calculating a center of gravity of the virtual fluid based on the motion; and activating one or more of the plurality of vibrotactile actuators of the physical vessel based on the calculated center of gravity.
Example 2—The method of example 1, wherein providing haptic output comprises modulating activation of the plurality of vibrotactile actuators based on spatial variations of actuator locations and temporal variations of actuator activation timing corresponding to the motion of the virtual fluid.
Example 3—The method of example 2, wherein modulating activation comprises at least one of: modifying an intensity parameter of at least one of the plurality of vibrotactile actuators over time; generating temporally asymmetric vibrations, wherein vibration amplitude or frequency differs between rising and falling portions of a vibration cycle; or pulsing at least one of the plurality of vibrotactile actuators.
Example 4—The method of example 1, wherein detecting that the user interaction satisfies the acceleration threshold comprises comparing acceleration data derived from the position tracking data to a configurable threshold parameter.
Example 5—The method of example 1, further comprising, after updating the virtual environment and activating the plurality of vibrotactile actuators: obtaining additional position tracking data corresponding to the physical vessel; updating the virtual environment to display a different relative position of the virtual fluid based on the motion; and re-activating at least one of the plurality of vibrotactile actuators based on the different relative position.
Example 6—The method of example 1, wherein updating the virtual environment comprises synchronizing vibration of the plurality of vibrotactile actuators with shaking or swirling motions of the physical vessel.
Example 7—The method of example 1, further comprising deactivating the plurality of vibrotactile actuators when the motion of the virtual fluid falls below a motion threshold value parameter.
Example 8—The method of example 1, wherein the virtual container and the physical vessel are substantially geometrically identical.
Example 9—The method of example 1, wherein the plurality of vibrotactile actuators are arranged in a generally circular array around the interior surface of the physical vessel.
Example 10—The method of example 1, wherein providing haptic output further comprises simulating an impact event of the virtual fluid, wherein the impact event is determined based on a collision between a simulated fluid volume and a boundary of the virtual container, using at least one of the plurality of vibrotactile actuators.
Example 11—The method of example 1, wherein an intensity parameter and a duration parameter of haptic signals from the plurality of vibrotactile actuators are adjustable based on configuration settings specifying at least one of: virtual fluid viscosity, virtual container geometry, virtual container size, or virtual container mass.
Example 12—The method of example 1, wherein the user interaction with the physical vessel comprises at least one of: a shaking motion, a tilting motion, a tapping motion, or a grasping motion.
Example 13—A system comprising: processing circuitry; and non-transitory computer-readable media storing instructions that, when executed by the processing circuitry, cause the processing circuitry to: obtain position tracking data corresponding to a physical vessel equipped with a plurality of vibrotactile actuators arranged along an interior surface of the physical vessel; output a virtual environment for display to a display interface, wherein the virtual environment includes a virtual container representing the physical vessel and a virtual fluid inside the virtual container; detect, based on the position tracking data, that a user interaction with the physical vessel satisfies an acceleration threshold; and in response to detecting that the user interaction with the physical vessel satisfies the acceleration threshold, provide haptic output from the plurality of vibrotactile actuators, wherein to provide the haptic output, the processing circuitry is further configured to: calculate a motion of the virtual fluid within the virtual container using the user interaction detected with the physical vessel; update the virtual environment to display a relative position of the virtual fluid based on the motion; calculate a center of gravity of the virtual fluid based on the motion; and activate one or more of the plurality of vibrotactile actuators of the physical vessel based on the calculated center of gravity.
Example 14—The system of example 13, wherein to provide the haptic output, the processing circuitry is further configured to modulate activation of the plurality of vibrotactile actuators based on spatial variations of actuator locations and temporal variations of actuator activation timing corresponding to the motion of the virtual fluid.
Example 15—The system of example 14, wherein to modulate activation, the processing circuitry is further configured to perform at least one of: modify an intensity parameter of at least one of the plurality of vibrotactile actuators over time; generate temporally asymmetric vibrations wherein vibration amplitude or frequency differs between rising and falling portions of a vibration cycle; or pulse at least one of the plurality of vibrotactile actuators.
Example 16—The system of example 13, wherein to detect that the user interaction satisfies the acceleration threshold, the processing circuitry is further configured to compare acceleration data derived from the position tracking data to a configurable threshold parameter.
Example 17—The system of example 13, wherein to update the virtual environment, the processing circuitry is further configured to synchronize vibration of the plurality of vibrotactile actuators with shaking or swirling motions of the physical vessel.
Example 18—The system of example 13, wherein the virtual container and the physical vessel are substantially geometrically identical.
Example 19—The system of example 13, wherein an intensity parameter and a duration parameter of haptic signals from the plurality of vibrotactile actuators are adjustable based on configuration settings specifying at least one of: virtual fluid viscosity, virtual container geometry, virtual container size, or virtual container mass.
Example 20—A non-transitory computer-readable medium storing instructions that, when executed by processing circuitry, cause the processing circuitry to: obtain position tracking data corresponding to a physical vessel equipped with a plurality of vibrotactile actuators arranged along an interior surface of the physical vessel; output a virtual environment for display to a display interface, wherein the virtual environment includes a virtual container representing the physical vessel and a virtual fluid inside the virtual container; detect, based on the position tracking data, that a user interaction with the physical vessel satisfies an acceleration threshold; and in response to detecting that the user interaction with the physical vessel satisfies the acceleration threshold, provide haptic output from the plurality of vibrotactile actuators, wherein to provide the haptic output, the instructions further configure the processing circuitry to: calculate a motion of the virtual fluid within the virtual container using the user interaction detected with the physical vessel; update the virtual environment to display a relative position of the virtual fluid based on the motion; calculate a center of gravity of the virtual fluid based on the motion; and activate one or more of the plurality of vibrotactile actuators of the physical vessel based on the calculated center of gravity.
Example 21—A computer program product comprising one or more instructions that, when executed by at least one processor, cause the at least one processor to perform any of the methods of examples 1-12.
Example 22—A device comprising means for performing any of the methods of examples 1-12.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

In accordance with the examples of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

What is claimed is:

1. A method comprising:
obtaining position tracking data corresponding to a physical vessel equipped with a plurality of vibrotactile actuators arranged along an interior surface of the physical vessel;
outputting a virtual environment for display to a display interface, wherein the virtual environment includes a virtual container representing the physical vessel and a virtual fluid inside the virtual container;
detecting, based on the position tracking data, that a user interaction with the physical vessel satisfies an acceleration threshold; and
in response to detecting that the user interaction with the physical vessel satisfies the acceleration threshold, providing haptic output from the plurality of vibrotactile actuators, wherein the providing includes:
calculating a motion of the virtual fluid within the virtual container using the user interaction detected with the physical vessel;
updating the virtual environment to display a relative position of the virtual fluid based on the motion;
calculating a center of gravity of the virtual fluid based on the motion; and
activating one or more of the plurality of vibrotactile actuators of the physical vessel based on the calculated center of gravity.

2. The method of claim 1, wherein providing haptic output comprises modulating activation of the plurality of vibrotactile actuators based on spatial variations of actuator locations and temporal variations of actuator activation timing corresponding to the motion of the virtual fluid.

3. The method of claim 2, wherein modulating activation comprises at least one of:
modifying an intensity parameter of at least one of the plurality of vibrotactile actuators over time;
generating temporally asymmetric vibrations, wherein vibration amplitude or frequency differs between rising and falling portions of a vibration cycle; or
pulsing at least one of the plurality of vibrotactile actuators.

4. The method of claim 1, wherein detecting that the user interaction satisfies the acceleration threshold comprises comparing acceleration data derived from the position tracking data to a configurable threshold parameter.

5. The method of claim 1, further comprising, after updating the virtual environment and activating the plurality of vibrotactile actuators:
obtaining additional position tracking data corresponding to the physical vessel;
updating the virtual environment to display a different relative position of the virtual fluid based on the motion; and
re-activating at least one of the plurality of vibrotactile actuators based on the different relative position.

6. The method of claim 1, wherein updating the virtual environment comprises synchronizing vibration of the plurality of vibrotactile actuators with shaking or swirling motions of the physical vessel.

7. The method of claim 1, further comprising deactivating the plurality of vibrotactile actuators when the motion of the virtual fluid falls below a motion threshold value parameter.

8. The method of claim 1, wherein the virtual container and the physical vessel are substantially geometrically identical.

9. The method of claim 1, wherein the plurality of vibrotactile actuators are arranged in a generally circular array around the interior surface of the physical vessel.

10. The method of claim 1, wherein providing haptic output further comprises simulating an impact event of the virtual fluid, wherein the impact event is determined based on a collision between a simulated fluid volume and a boundary of the virtual container, using at least one of the plurality of vibrotactile actuators.

11. The method of claim 1, wherein an intensity parameter and a duration parameter of haptic signals from the plurality of vibrotactile actuators are adjustable based on configuration settings specifying at least one of: virtual fluid viscosity, virtual container geometry, virtual container size, or virtual container mass.

12. The method of claim 1, wherein the user interaction with the physical vessel comprises at least one of: a shaking motion, a tilting motion, a tapping motion, or a grasping motion.

13. A system comprising:
processing circuitry; and
non-transitory computer-readable media storing instructions that, when executed by the processing circuitry, cause the processing circuitry to:
obtain position tracking data corresponding to a physical vessel equipped with a plurality of vibrotactile actuators arranged along an interior surface of the physical vessel;
output a virtual environment for display to a display interface, wherein the virtual environment includes a virtual container representing the physical vessel and a virtual fluid inside the virtual container;
detect, based on the position tracking data, that a user interaction with the physical vessel satisfies an acceleration threshold; and
in response to detecting that the user interaction with the physical vessel satisfies the acceleration threshold, provide haptic output from the plurality of vibrotactile actuators, wherein to provide the haptic output, the processing circuitry is further configured to:
calculate a motion of the virtual fluid within the virtual container using the user interaction detected with the physical vessel;
update the virtual environment to display a relative position of the virtual fluid based on the motion;
calculate a center of gravity of the virtual fluid based on the motion; and
activate one or more of the plurality of vibrotactile actuators of the physical vessel based on the calculated center of gravity.

14. The system of claim 13, wherein to provide the haptic output, the processing circuitry is further configured to modulate activation of the plurality of vibrotactile actuators based on spatial variations of actuator locations and temporal variations of actuator activation timing corresponding to the motion of the virtual fluid.

15. The system of claim 14, wherein to modulate activation, the processing circuitry is further configured to perform at least one of:
modify an intensity parameter of at least one of the plurality of vibrotactile actuators over time;
generate temporally asymmetric vibrations wherein vibration amplitude or frequency differs between rising and falling portions of a vibration cycle; or
pulse at least one of the plurality of vibrotactile actuators.

16. The system of claim 13, wherein to detect that the user interaction satisfies the acceleration threshold, the processing circuitry is further configured to compare acceleration data derived from the position tracking data to a configurable threshold parameter.

17. The system of claim 13, wherein to update the virtual environment, the processing circuitry is further configured to synchronize vibration of the plurality of vibrotactile actuators with shaking or swirling motions of the physical vessel.

18. The system of claim 13, wherein the virtual container and the physical vessel are substantially geometrically identical.

19. The system of claim 13, wherein an intensity parameter and a duration parameter of haptic signals from the plurality of vibrotactile actuators are adjustable based on configuration settings specifying at least one of: virtual fluid viscosity, virtual container geometry, virtual container size, or virtual container mass.

20. A non-transitory computer-readable medium storing instructions that, when executed by processing circuitry, cause the processing circuitry to:
obtain position tracking data corresponding to a physical vessel equipped with a plurality of vibrotactile actuators arranged along an interior surface of the physical vessel;
output a virtual environment for display to a display interface, wherein the virtual environment includes a virtual container representing the physical vessel and a virtual fluid inside the virtual container;
detect, based on the position tracking data, that a user interaction with the physical vessel satisfies an acceleration threshold; and
in response to detecting that the user interaction with the physical vessel satisfies the acceleration threshold, provide haptic output from the plurality of vibrotactile actuators, wherein to provide the haptic output, the instructions further configure the processing circuitry to:
calculate a motion of the virtual fluid within the virtual container using the user interaction detected with the physical vessel;
update the virtual environment to display a relative position of the virtual fluid based on the motion;
calculate a center of gravity of the virtual fluid based on the motion; and
activate one or more of the plurality of vibrotactile actuators of the physical vessel based on the calculated center of gravity.
